(19) United States
(12) Patent Application Publication
(10) Pub. No.: US 2025/0010551 A1
(43) Pub. Date: Jan. 9, 2025

(54) PRINTING DATA GENERATION DEVICE, PRINTING DATA GENERATION METHOD, PROGRAM, PRINTING SYSTEM, AND MANUFACTURING METHOD OF THREE-DIMENSIONAL STRUCTURE

(71) Applicant: FUJIFILM Corporation, Tokyo (JP)

(72) Inventors: Yuta SUMIYOSHI, Kanagawa (JP); Tadashi KYOSO, Kanagawa (JP); Mitsuru SAWANO, Kanagawa (JP)

(73) Assignee: FUJIFILM Corporation, Tokyo (JP)

(21) Appl. No.: 18/890,761

(22) Filed: Sep. 20, 2024

Related U.S. Application Data
(63) Continuation of application No. PCT/JP2023/009551, filed on Mar. 13, 2023.

(30) Foreign Application Priority Data
Mar. 23, 2022 (JP) 2022-046645

(51) Int. Cl. B29C 64/386; B29C 64/112; B33Y 10/00; B33Y 30/00; B33Y 50/00

(52) U.S. Cl. CPC B29C 64/386; B29C 64/112; B33Y 10/00; B33Y 30/00; B33Y 50/00

(57) ABSTRACT

A printing data generation device may generate printing data of high productivity for laminating a three-dimensional structure with a liquid. A processor is configured to, in converting three-dimensional data of a three-dimensional structure to be formed using a liquid into a plurality of pieces of two-dimensional slice data in a lamination order of the liquid by dividing the three-dimensional data in a direction parallel to an installation surface of a substrate, perform any of processing of shifting data of a region of a component top surface in a lamination direction in the three-dimensional data to the lamination direction, processing of shifting the data of the region of the component top surface in the lamination direction in the plurality of pieces of two-dimensional slice data to the lamination direction, or processing of rearranging the lamination direction of the plurality of pieces of two-dimensional slice data.

### CROSS-REFERENCE TO RELATED APPLICATIONS

The present application is a Continuation of PCT International Application No. PCT/JP2023/009551 filed on Mar. 13, 2023 claiming priority under 35 U.S.C § 119(a) to Japanese Patent Application No. 2022-046645 filed on Mar. 23, 2022. Each of the above applications is hereby expressly incorporated by reference, in its entirety, into the present application.

### BACKGROUND OF THE INVENTION

### 1. Field of the Invention

The present invention relates to a printing data generation device, a printing data generation method, a program, a printing system, and a manufacturing method of a three-dimensional structure, and particularly to a technique for forming a three-dimensional structure by jetting a liquid.

### 2. Description of the Related Art

In a case of forming a three-dimensional structure using an ink jet method, it is required to overprint a two-dimensional pattern a plurality of times. For example, JP2016-013671A discloses a technique for forming a protrusion and a recess on a recording medium using an ink jet printer by dividing the protrusion and the recess into a plurality of layers and stacking each layer. In addition, JP2020-151870A discloses a technique for setting a lamination layer based on printing data converted from shaping data and forming a laminate of photocurable color inks in an order of layers.

### SUMMARY OF THE INVENTION

In a case of depositing an ink using an ink jet method to form an electromagnetic interference (EMI) shield (electromagnetic wave shield) for a complicated three-dimensional structure in which a component is mounted on a printed substrate, performing overprinting using two-dimensional data simply converted from data of the three-dimensional structure to which the ink sticks may decrease productivity.

The present invention has been conceived in view of such circumstances, and an object of the present invention is to provide a printing data generation device, a printing data generation method, a program, a printing system, and a manufacturing method of a three-dimensional structure that generate printing data of high productivity for laminating a three-dimensional structure with a liquid.

A printing data generation device for achieving the object is a printing data generation device that generates printing data of a printing apparatus which forms a three-dimensional structure of a liquid by applying, based on the printing data, the liquid to a protruding and recessed surface including a component top surface and an installation surface of a substrate having the installation surface on which a component is installed, the printing apparatus including a liquid jetting head including a nozzle that jets a liquid, a relative moving mechanism that relatively moves the liquid jetting head and the substrate in a direction parallel to the installation surface, and a control device that laminates the protruding and recessed surface with the liquid for each relative movement by jetting the liquid to the substrate from the nozzle based on the printing data, the printing data generation device comprising at least one processor, and at least one memory that stores an instruction to be executed by the at least one processor, in which the at least one processor is configured to acquire three-dimensional data of the three-dimensional structure to be formed using the liquid, convert the three-dimensional data into a plurality of pieces of two-dimensional slice data in a lamination order by dividing the three-dimensional data in the direction parallel to the installation surface, and perform any of first shift processing of shifting data of a region of the component top surface in a lamination direction of the liquid in the three-dimensional data to the lamination direction, second shift processing of shifting the data of the region of the component top surface in the lamination direction in the plurality of pieces of two-dimensional slice data to the lamination direction, or rearrangement processing of rearranging the lamination order of the plurality of pieces of two-dimensional slice data. According to the present aspect, printing data of high productivity for laminating a three-dimensional structure with a liquid can be generated.

It is preferable that the first shift processing is processing of joining a position touching the component top surface to a position touching the installation surface in the three-dimensional data. Accordingly, the number of pieces of two-dimensional slice data can be reduced.

It is preferable that in a case where M and N are integers satisfying M≤N, two-dimensional slice data of a lowest layer touching the installation surface among the plurality of pieces of two-dimensional slice data is referred to as two-dimensional slice data of a first layer, two-dimensional slice data of a layer touching the component top surface is referred to as two-dimensional slice data of an M-th layer, and two-dimensional slice data of an uppermost layer in the lamination direction is referred to as two-dimensional slice data of an N-th layer, the second shift processing is processing of joining the region of the component top surface in the lamination direction in the two-dimensional slice data of the M-th layer to the N-th layer to the first layer to an (N−M+1)-th layer, respectively. Accordingly, the number of pieces of two-dimensional slice data can be reduced.

It is preferable that in a case where N is an integer, the plurality of pieces of two-dimensional slice data include two-dimensional slice data of a first layer that is a lowermost layer touching the installation surface to two-dimensional slice data of an N-th layer that is two-dimensional slice data of an uppermost layer in the lamination direction, and the rearrangement processing is processing of converting the two-dimensional slice data of the first layer to the N-th layer into two-dimensional slice data of the N-th layer to the first layer, respectively, in the plurality of pieces of two-dimensional slice data. Accordingly, since an amount of the liquid applied using the two-dimensional slice data of a lower layer is increased, productivity can be improved.

It is preferable that the at least one processor is configured to convert the three-dimensional data into the two-dimensional slice data by providing a gap in a region of an edge part of the component top surface.

It is preferable that the at least one processor is configured to convert the three-dimensional data into the two-dimensional slice data by reducing a jetting amount of the liquid in a region touching a side surface of the component.

It is preferable that the at least one processor is configured to generate the three-dimensional data based on information about the protruding and recessed surface. Accordingly, a three-dimensional structure corresponding to the information about the protruding and recessed surface can be formed.

It is preferable that the at least one processor is configured to acquire the information about the protruding and recessed surface based on an image obtained by imaging the substrate having the installation surface on which the component is installed via a camera. Accordingly, the information about the protruding and recessed surface for each substrate can be acquired.

It is preferable that the at least one processor is configured to convert the three-dimensional data into a plurality of pieces of two-dimensional slice data by dividing the three-dimensional data by a height of an ink layer in the lamination direction formed by the relative movement performed once. Accordingly, lamination with the liquid can be performed based on the two-dimensional slice data.

A printing system for achieving the object is a printing system comprising a printing apparatus which forms a three-dimensional structure of a liquid by applying, based on printing data, the liquid to a protruding and recessed surface including a component top surface and an installation surface of a substrate having the installation surface on which a component is installed, the printing apparatus including a liquid jetting head including a nozzle that jets a liquid, a relative moving mechanism that relatively moves the liquid jetting head and the substrate in a direction parallel to the installation surface, and a control device that laminates the protruding and recessed surface with the liquid for each relative movement by jetting the liquid to the protruding and recessed surface of the substrate from the nozzle based on the printing data, and the printing data generation device. According to the present aspect, a three-dimensional structure can be formed using printing data of high productivity.

It is preferable that the printing system further comprises a light source that irradiates the substrate with an active energy ray, in which the relative moving mechanism relatively moves the light source and the substrate in the direction parallel to the installation surface, the liquid has an active energy ray curing property, and the control device reduces an irradiation amount of the active energy ray for the liquid applied to the protruding and recessed surface in initial relative movement relative to an irradiation amount of the active energy ray for the liquid applied in the relative movement performed for the second times or later. Accordingly, the liquid applied to the installation surface is likely to spread, and the liquid can be spread to the side surface and a lower portion of the component.

It is preferable that the liquid has an insulating property. Accordingly, the component can be covered with an insulating film.

A printing data generation method for achieving the object is a printing data generation method of generating printing data of a printing apparatus which forms a three-dimensional structure of a liquid by applying, based on the printing data, the liquid to a protruding and recessed surface including a component top surface and an installation surface of a substrate having the installation surface on which a component is installed, the printing apparatus including a liquid jetting head including a nozzle that jets a liquid, a relative moving mechanism that relatively moves the liquid jetting head and the substrate in a direction parallel to the installation surface, and a control device that laminates the protruding and recessed surface with the liquid for each relative movement by jetting the liquid to the protruding and recessed surface of the substrate from the nozzle based on the printing data, the printing data generation method comprising an acquisition step of acquiring three-dimensional data of the three-dimensional structure to be formed using the liquid, a conversion step of converting the three-dimensional data into a plurality of pieces of two-dimensional slice data in a lamination order by dividing the three-dimensional data in the direction parallel to the installation surface, and a processing step of performing any of first shift processing of shifting data of a region of the component top surface in a lamination direction of the liquid in the three-dimensional data to the lamination direction, second shift processing of shifting the data of the region of the component top surface in the lamination direction in the plurality of pieces of two-dimensional slice data to the lamination direction, or rearrangement processing of rearranging the lamination order of the plurality of pieces of two-dimensional slice data. According to the present aspect, printing data of high productivity for laminating a three-dimensional structure with a liquid can be generated.

A manufacturing method of a three-dimensional structure for achieving the object is a manufacturing method of a three-dimensional structure, comprising the printing data generation method, and a lamination step of relatively moving a liquid jetting head including a nozzle that jets a liquid and a substrate having a protruding and recessed surface including a component top surface and an installation surface on which a component is installed, in a direction parallel to the installation surface, and jetting the liquid to the protruding and recessed surface of the substrate from the nozzle based on printing data to laminate the protruding and recessed surface with the liquid for each relative movement. According to the present aspect, productivity in forming a three-dimensional structure can be improved.

An aspect of a program for achieving the object is a program causing a computer to execute the printing data generation method. According to the present aspect, printing data of high productivity for laminating a three-dimensional structure with a liquid can be generated. The present aspect may also include a non-transitory computer-readable storage medium on which the program is recorded.

According to the present invention, printing data of high productivity for laminating a three-dimensional structure with a liquid can be generated.

### BRIEF DESCRIPTION OF THE DRAWINGS

FIG. 1 is a perspective view of an electric component mounting substrate.

FIG. 2 is a flowchart illustrating an example of a manufacturing process of a printed substrate.

FIGS. 3A and 3B are diagrams for describing a layout of the printed substrate.

FIG. 4 is a plan view of an ink jet printing apparatus.

FIG. 5 is a side view of the ink jet printing apparatus.

FIG. 6 is a perspective view illustrating a configuration of a tip part of an ink jet head.

FIG. 7 is a partial enlarged view of a nozzle surface.

FIG. 8 is a plan view of the nozzle surface.

FIG. 9 is a cross-sectional view illustrating a three-dimensional structure of an ejector.

FIG. 10 is a functional block diagram illustrating an electric configuration of the ink jet printing apparatus.

FIGS. 11A to 11D are diagrams illustrating an example of deformation of printing pattern data using a data processing unit.

FIGS. 12A and 12B are cross-sectional views illustrating an electromagnetic wave shield.

FIGS. 13A and 13B are diagrams for describing printing data generation processing in the related art.

FIGS. 14A and 14B are diagrams for describing the printing data generation processing in the related art.

FIG. 15 is a block diagram of a printing data generation device according to a first embodiment.

FIG. 16 is a flowchart illustrating processing of a printing data generation method according to the first embodiment.

FIGS. 17A to 17E are diagrams for describing data processing using the printing data generation method according to the first embodiment.

FIGS. 18A to 18C are diagrams for describing reduction of the number of layers according to the first embodiment.

FIG. 19 is a block diagram of a printing data generation device according to a second embodiment.

FIG. 20 is a flowchart illustrating processing of a printing data generation method according to the second embodiment.

FIGS. 21A to 21E are diagrams for describing data processing using the printing data generation method according to the second embodiment.

FIG. 22 is a block diagram of a printing data generation device according to a third embodiment.

FIG. 23 is a flowchart illustrating processing of a printing data generation method according to the third embodiment.

FIGS. 24A to 24D are diagrams for describing data processing using the printing data generation method according to the third embodiment.

### DESCRIPTION OF THE PREFERRED EMBODIMENTS

Hereinafter, preferred embodiments of the present invention will be described in detail with reference to the accompanying drawings. In the present embodiment, a case where an insulating ink and a conductive ink are applied to a printed substrate will be described. Applying the insulating ink and the conductive ink to required locations on the printed substrate makes it possible to connect electrical wiring lines using the conductive ink or apply a function of an electromagnetic wave shield while preventing a short circuit between electrodes present on the printed substrate.

### <Configuration of Printed Substrate>

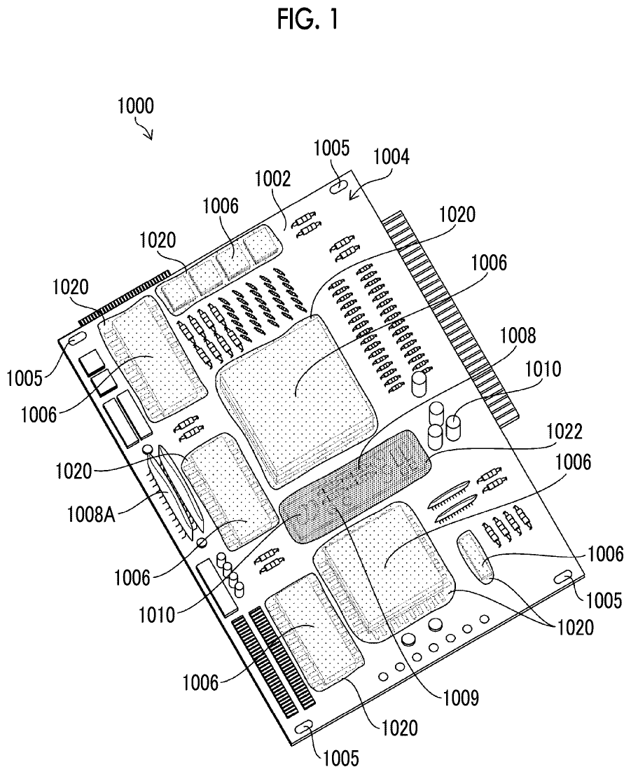

FIG. 1 is a perspective view of an electric component mounting substrate 1000. As illustrated in FIG. 1, the electric component mounting substrate 1000 is obtained by mounting an IC 1006, a resistor 1008, and a capacitor 1010 on a component mounting surface 1004 of a wiring substrate 1002. The electric component mounting substrate 1000 and the wiring substrate 1002 are examples of a printed substrate.

In the electric component mounting substrate 1000, a conductive pattern 1020 is formed for the IC 1006, and an insulating coating 1022 is formed for the resistor 1008 and the capacitor 1010. In addition, in the electric component mounting substrate 1000, the insulating coating 1022 is formed for an exposed electrode 1009 on which an electronic component of the wiring substrate 1002 is not mounted.

While FIG. 1 illustrates an example in which one surface of the wiring substrate 1002 is the component mounting surface 1004, both surfaces of the wiring substrate 1002 may be component mounting surfaces.

Four alignment marks 1005 are provided on the wiring substrate 1002. The alignment marks 1005 indicate reference positions on the wiring substrate 1002. The number, positions, and shapes of the alignment marks 1005 can be appropriately determined.

The IC 1006 is an electronic component in which a semiconductor integrated circuit is sealed in a package of resin or the like. In the IC 1006, an electrode is exposed to an outside of the package. IC is the abbreviation for Integrated Circuit.

The resistor 1008 includes an electric resistance element. In addition, the resistor 1008 includes a resistor array 1008A in which a plurality of integrated electric resistance elements are sealed in a package of resin or the like. The capacitor 1010 includes various capacitors such as an electrolytic capacitor and a ceramic capacitor.

An insulating pattern (not illustrated) is formed, using the insulating ink, in a region in which the IC 1006 is disposed among electronic components mounted on the wiring substrate 1002. Furthermore, the conductive pattern 1020 is formed for at least a part of the insulating pattern using the conductive ink.

The conductive pattern 1020 is formed by disposing the conductive ink in a region in which the conductive pattern 1020 is formed using a printing apparatus (not illustrated) and then drying and curing continuous ink dots of the conductive ink using a drying and curing device (not illustrated).

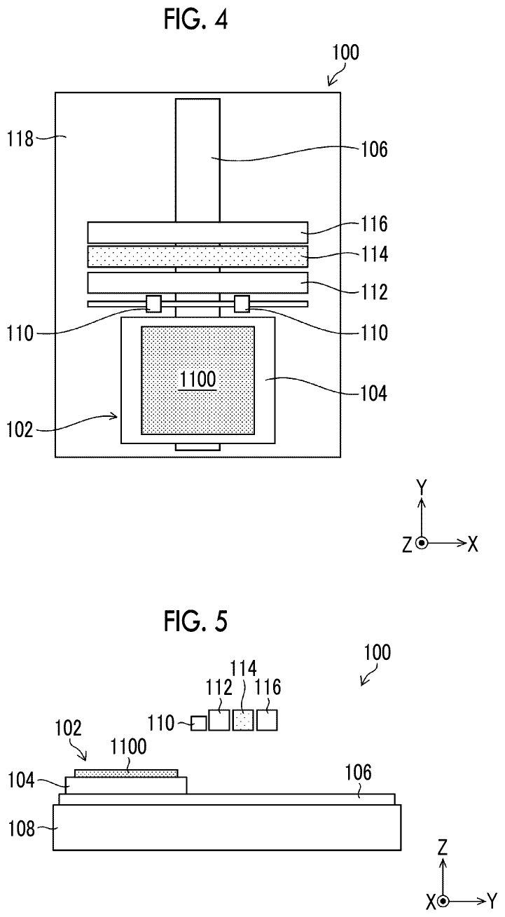

The insulating coating 1022 and the insulating pattern are formed by disposing the insulating ink in regions in which the insulating coating 1022 and the insulating pattern are formed using the printing device (for example, an ink jet printing apparatus 100 illustrated in FIG. 4) and drying and curing the insulating ink.

The conductive pattern 1020 functions as an electromagnetic wave shield for suppressing electromagnetic waves received by the IC 1006 and suppressing electromagnetic waves released from the IC 1006. The insulating pattern functions as an insulating member that secures electrical insulation between the conductive pattern 1020 and the IC 1006, an adhesive member that secures adhesiveness between the conductive pattern 1020 and the IC 1006, a member that secures flatness of a base of the conductive pattern 1020, and the like.

In the wiring substrate 1002, the conductive pattern 1020 is not formed in at least a part of a component region in which an electronic component not requiring the electromagnetic wave shield is disposed, and the part is coated with the insulating coating 1022. The electronic component not requiring the electromagnetic wave shield includes a diode, a coil, a transformer, a switch, and the like, in addition to the resistor 1008 and the capacitor 1010.

In addition, an electrode region in which the electrode 1009 is disposed is coated with the insulating coating 1022. The insulating coating 1022 suppresses a short circuit of an electric circuit caused by the conductive ink that changes into fine particles in forming the conductive pattern 1020 and sticks to the resistor 1008 or the like.

### <Manufacturing Process of Printed Substrate>

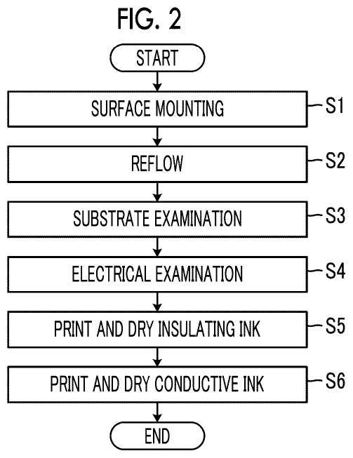

A manufacturing process of the printed substrate (for example, the electric component mounting substrate 1000 illustrated in FIG. 1) will be described. FIG. 2 is a flowchart illustrating an example of the manufacturing process of the printed substrate. In FIG. 2, only a main process is illustrated, and preceding and succeeding processes are omitted.

A surface mounting step in step S1 is a process of placing various electronic components such as the IC, the electric resistance element, and the capacitor, using a mounter (not illustrated), on the printed substrate on which cream solder is printed using a cream solder coating device (not illustrated).

A reflow step in step S2 is a process of connecting the printed substrate to the electronic components by heating the wiring substrate using a reflow furnace (not illustrated) to melt the heated high-temperature solder.

A substrate examination step in step S3 is a step of checking whether or not the electronic components are appropriately fixed on the printed substrate by performing automated optical inspection (AOI) as visual inspection on the printed substrate on which the electronic components are mounted, using a substrate visual examination device.

An electrical examination step in step S4 is a step of checking whether or not electrical connection is made and whether or not signals are appropriately processed for the printed substrate.

An insulating ink printing and drying step in step S5 is a step of printing the insulating ink having an insulating property on the printed substrate and drying the insulating ink. Various types of the insulating ink such as an ultraviolet curable-type ink, an aqueous ink, and a solvent ink can be considered. In the present embodiment, the insulating ink is an ultraviolet curable-type ink. The ultraviolet curable-type ink is an ink that has viscosity increased by irradiation (exposure) with ultraviolet rays and that is completely cured through a semi-cured state (an example of “active energy ray curability”). Here, drying and curing are performed by performing irradiation with the ultraviolet rays using an ultraviolet exposure device (for example, an ultraviolet exposure machine 114 illustrated in FIG. 4).

A conductive ink printing and drying step in step S6 is a step of applying the conductive ink including a conductive substance to the printed substrate. Various types of the conductive ink such as an ultraviolet curable-type ink, an aqueous ink, and a solvent ink can be considered. In the present embodiment, the conductive ink is an ultraviolet curable-type ink and is an ink in which silver or copper is dissolved. The conductive ink may be an ink in which silver or copper nanoparticles are dispersed. In such a conductive ink, metal atoms generate heat because of ultraviolet rays, and a solvent volatilizes. Accordingly, viscosity of the ink is increased, and the ink is finally cured. Here, drying and curing are performed by performing irradiation with the ultraviolet rays using an ultraviolet exposure device.

The insulating ink and the conductive ink can be dried and cured using hot air, near infrared (NIR) rays, or the like depending on a type of the ink, which will not be described here.

### <Layout of Printed Substrate>

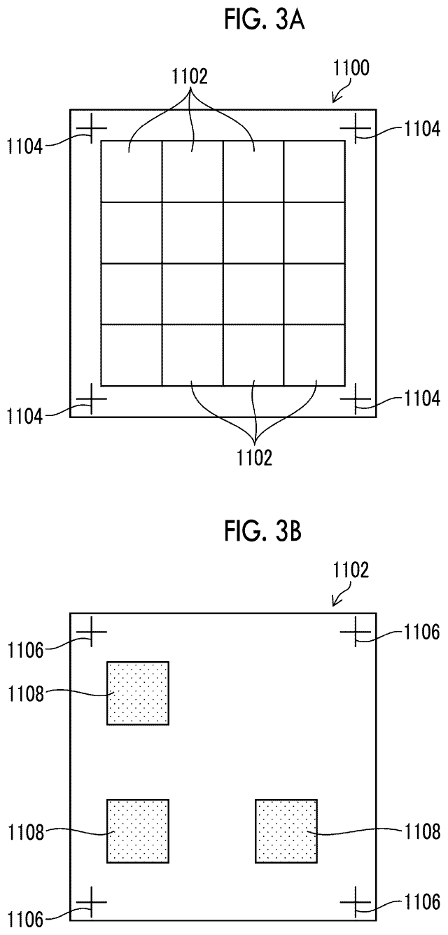

FIGS. 3A and 3B are diagrams for describing a layout of the printed substrate. FIG. 3A illustrates a large substrate 1100. The large substrate 1100 is a multi-imposition substrate. Here, total 16 individual substrates 1102 of 4 rows×4 columns are laid out. The large substrate 1100 and the individual substrates 1102 are examples of the printed substrate. In addition, large substrate alignment marks 1104 are printed on four corners of the large substrate 1100.

FIG. 3B illustrates an enlarged view of one individual substrate 1102 laid out on the large substrate 1100. A wiring pattern is formed on a surface of the individual substrate 1102, which is not illustrated here. Individual substrate alignment marks 1106 are printed on four corners of the individual substrate 1102. In addition, electronic components 1108 are mounted on the individual substrate 1102. The large substrate 1100 is finally cut and divided into the individual substrates 1102. The electric component mounting substrate 1000 illustrated in FIG. 1 corresponds to a cut individual substrate 1102. In addition, the alignment marks 1005 illustrated in FIG. 1 correspond to the individual substrate alignment marks 1106. [0046] The large substrate alignment marks 1104 and the individual substrate alignment marks 1106 are used as reference positions in printing the insulating ink and the conductive ink. Positions at which the large substrate alignment marks 1104 and the individual substrate alignment marks 1106 are disposed are not limited to four corners. In a case of performing positioning with higher accuracy, the large substrate alignment marks 1104 and the individual substrate alignment marks 1106 may be additionally provided.

In addition, in a case of using a high-density printed substrate on which alignment marks cannot be provided, a wiring line created using a semiconductor process, an electrode for electrical examination, a via hole pattern for conduction inside the substrate, or the like may be used as a reference, instead of the large substrate alignment marks 1104 and the individual substrate alignment marks 1106.

### <Printing Apparatus>

A printing apparatus that can appropriately apply an ink to a side surface of a protruding portion of a printed substrate having a protrusion and a recess on a surface will be described. In the present embodiment, a configuration of the printing apparatus applying the insulating ink can be approximately the same as a configuration of the printing apparatus applying the conductive ink. The configuration of the printing apparatus applying the insulating ink and the configuration of the printing apparatus applying the conductive ink are not required to be the same, and it is desirable to prepare a printing apparatus corresponding to characteristics of each ink. Here, while an example of applying the ink to the large substrate 1100 will be described, the ink may be applied to the individual substrates 1102 after cutting the large substrate 1100 into the individual substrates 1102.

FIGS. 4 and 5 are a plan view and a side view of the ink jet printing apparatus according to the present embodiment. As illustrated in FIGS. 4 and 5, the ink jet printing apparatus 100 comprises a transport device 102, an alignment camera 110, an ink jet head 112, the ultraviolet exposure machine 114, a camera 116, and a pedestal 118.

### [Transport Device]

The transport device 102 transports the large substrate 1100 in a Y direction in a state where the component mounting surface of the large substrate 1100 faces in a +Z direction. Each of the alignment camera 110, the ink jet head 112, the ultraviolet exposure machine 114, and the camera 116 is disposed on a side in the +Z direction of a transport path of the large substrate 1100 for the transport device 102 along the transport path.

The transport device 102 comprises a transport stage 104 that supports the wiring substrate 1002, and a moving mechanism 106 that moves the transport stage 104 along the Y direction.

The transport stage 104 comprises a fixing mechanism that fixes the large substrate 1100 in a state where the component mounting surface of the large substrate 1100 faces in the +Z direction. The fixing mechanism may mechanically fix the large substrate 1100 or hold the large substrate 1100 by suction by applying a negative pressure to the large substrate 1100.

The transport stage 104 may comprise an adjusting mechanism that adjusts a distance between the ink jet head 112 and the large substrate 1100 in a Z direction. The transport stage 104 may comprise an adjusting mechanism that adjusts a position of the large substrate 1100 in an X direction.

In the moving mechanism 106 (an example of a “relative moving mechanism”), a ball screw drive mechanism, a belt drive mechanism, and the like are connected to a rotation axis of a motor. The moving mechanism 106 may comprise a linear motor.

### [Alignment Camera]

The ink jet printing apparatus 100 comprises two alignment cameras 110. Each of the two alignment cameras 110 is an imaging device for identifying (aligning) the position of the large substrate 1100 by imaging the large substrate alignment marks 1104 and the individual substrate alignment marks 1106 provided on the large substrate 1100, and performing installation correction (centroid alignment and posture alignment) and correction (magnitude correction) of a size of the large substrate 1100 expanded through the reflow step.

The two alignment cameras 110 are disposed along the X direction. In addition, each of the two alignment cameras 110 is supported to be movable in the X direction.

The alignment cameras 110 comprise an imaging lens (not illustrated) and an imaging element (not illustrated). The imaging lens forms an image of reflected light, that is, subject light, from the large substrate 1100 on an imaging plane of the imaging element. The imaging element receives the subject light of the image formed on the imaging plane and outputs an image signal of the large substrate 1100. For example, a charge coupled device (CCD) sensor or a complementary metal oxide semiconductor (CMOS) sensor is used as the imaging element.

The large substrate alignment marks 1104 and the individual substrate alignment marks 1106 disposed at any positions of the large substrate 1100 in the X direction can be imaged by the two alignment cameras 110 movable in the X direction.

### [Ink Jet Head]

The ink jet head 112 (an example of a “liquid jetting head”) is disposed on a side in a −Y direction of the ultraviolet exposure machine 114 on the transport path of the large substrate 1100 for the transport device 102.

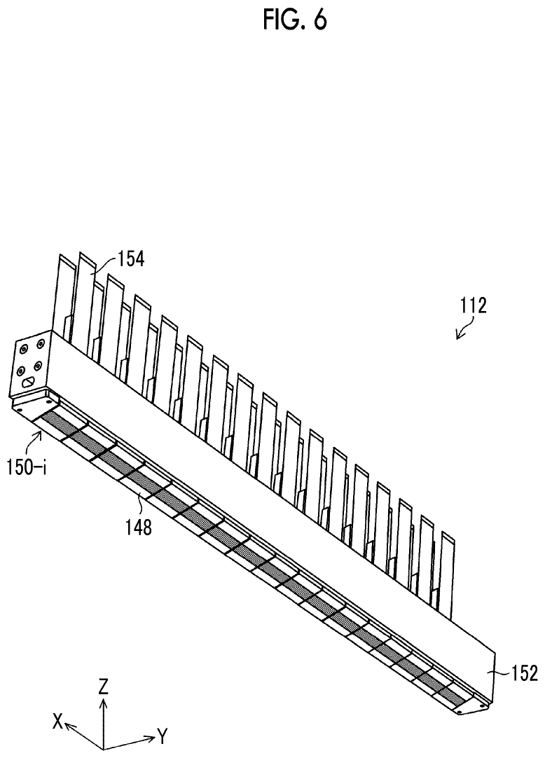

FIG. 6 is a perspective view illustrating a configuration of a tip part of the ink jet head 112. The ink jet head 112 is a line-type ink jet head including a nozzle array that can perform printing with a defined printing resolution on the whole printing region of the wiring substrate 1002 by performing scanning once in a width direction (X direction) of the wiring substrate 1002.

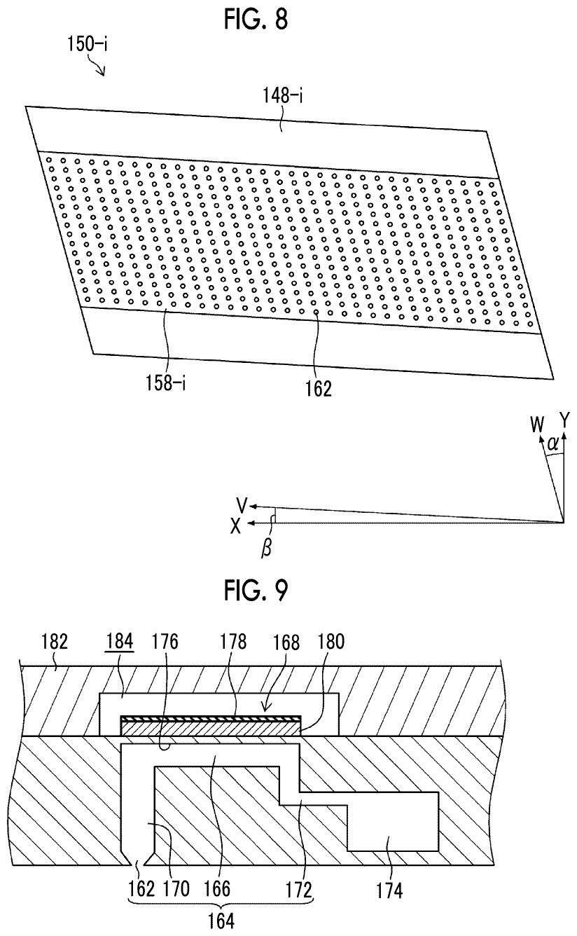

The tip part of the ink jet head 112 includes a nozzle surface 148. Nozzles 162 (refer to FIG. 8) that jet the ink are disposed on the nozzle surface 148.

In addition, the ink jet head 112 has a structure in which a plurality of head modules 150-i are connected in series along a longitudinal direction. Here, i is an integer of 1 to n. The head modules 150-i are attached to be integrated with a support frame 152. Each head module 150-i comprises a cable 154 for electrical connection.

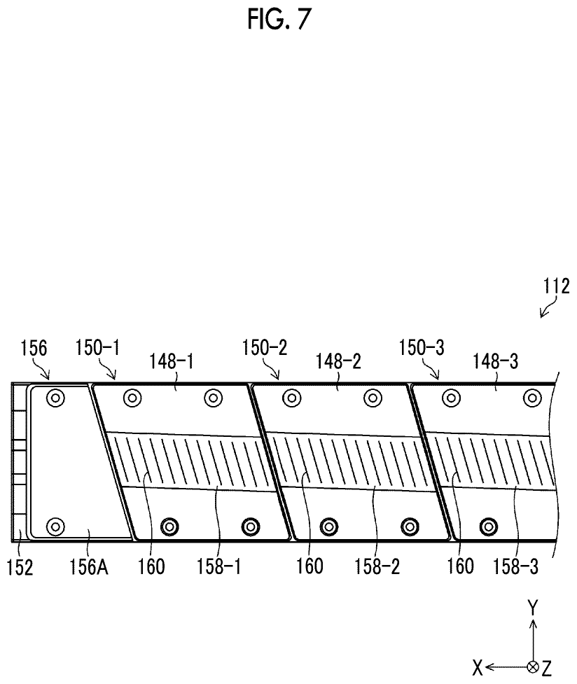

FIG. 7 is a partial enlarged view of the nozzle surface 148. A nozzle surface 148-i of the head module 150-i has a shape of a parallelogram. Dummy plates 156 are attached to both ends of the support frame 152. The nozzle surface 148 of the ink jet head 112 has an oblong shape as a whole together with surfaces 156A of the dummy plates 156.

A band-shaped nozzle disposition unit 158-i is comprised in a center part of the nozzle surface 148-i of the head module 150-i. The nozzle disposition unit 158-i functions as the actual nozzle surface 148-i. The nozzles 162 are comprised in the nozzle disposition unit 158-i. FIG. 7 does not individually illustrate the nozzles 162 and illustrates nozzle arrays 160 composed of a plurality of nozzles.

FIG. 8 is a plan view of the nozzle surface 148-i of the head module 150-i. A plurality of nozzles 162 are two-dimensionally arranged on the nozzle surface 148-i of the head module 150-i.

The head module 150-i has a planar shape of a parallelogram having long side edge surfaces along a V direction at an inclination of an angle β with respect to the X direction and short side edge surfaces along a W direction at an inclination of an angle α with respect to the Y direction.

In the head module 150-i, the plurality of nozzles 162 are disposed in a matrix in a row direction along the V direction and in a column direction along the W direction. In a case of using the ink jet head 112, a projected nozzle array obtained by projecting each nozzle 162 along the X direction can be considered to be equivalent to one nozzle array in which each nozzle 162 is arranged at approximately equal intervals with a nozzle density for achieving the maximum recording resolution in the X direction.

The approximately equal intervals mean actually equal intervals as jetting points that can be printed using the ink jet printing apparatus 100. For example, a concept of the equal intervals also includes a case of slightly varying the intervals considering at least one of manufacturing error or movement of liquid droplets on the large substrate 1100 because of landing interference.

An arrangement form of the nozzles 162 of the ink jet head 112 is not limited and can employ various nozzle arrangement forms. For example, a straight line arrangement of one array, a V-shaped arrangement, and a zigzag arrangement such as a W shape in which a V-shaped arrangement is a repeating unit may be used.

FIG. 9 is a cross-sectional view illustrating a three-dimensional structure of an ejector 164. The ejector 164 comprises the nozzle 162, a pressure chamber 166 that communicates with the nozzle 162, and a piezoelectric element 168. The nozzle 162 communicates with the pressure chamber 166 through a nozzle flow channel 170. The pressure chamber 166 communicates with a supply-side common branch flow channel 174 through an individual supply path 172.

A vibration plate 176 constituting a top surface of the pressure chamber 166 comprises a conductive layer (not illustrated) that functions as a common electrode corresponding to a lower electrode of the piezoelectric element 168. The pressure chamber 166, wall portions of other flow channel parts, and the vibration plate 176 can be made of silicon.

The vibration plate 176 is not limited to a silicon material and may be formed of a non-conductive material such as resin. The vibration plate 176 may be a vibration plate that is also used as the common electrode, by forming the vibration plate 176 using a metal material such as stainless steel.

A structure in which the vibration plate 176 is laminated with the piezoelectric element 168 constitutes a piezoelectric unimorph actuator. A volume of the pressure chamber 166 is changed by deforming a piezoelectric body 180 to bend the vibration plate 176 by applying a drive voltage to an individual electrode 178 that is an upper electrode of the piezoelectric element 168. A change in a pressure caused by the change in the volume of the pressure chamber 166 acts on the ink, and the ink is jetted from the nozzle 162.

In a case where the piezoelectric element 168 is restored to its original state after jetting the ink, the pressure chamber 166 is filled with a new ink from the supply-side common branch flow channel 174 through the individual supply path 172. An operation of filling the pressure chamber 166 with the ink will be referred to as refilling.

A plan-view shape of the pressure chamber 166 is not particularly limited and may be a quadrangular shape, other polygonal shapes, a circular shape, an elliptical shape, or the like. A cover plate 182 is provided above the individual electrode 178. The cover plate 182 is a member that secures a movable space 184 of the piezoelectric element 168 and seals a space around the piezoelectric element 168.

A supply-side ink chamber (not illustrated) and a collection-side ink chamber (not illustrated) are formed above the cover plate 182. The supply-side ink chamber is connected to a supply-side common main flow channel (not illustrated) through a communication path (not illustrated). The collection-side ink chamber is connected to a collection-side common main flow channel (not illustrated) through a communication path (not illustrated).

The ink jet head 112 configured as described above jets the ultraviolet curable-type ink (an example of a “liquid”) from the plurality of nozzles 162. Each of the plurality of nozzles 162 can jet the ultraviolet curable-type ink having a plurality of sizes and can dispose ink dots having a plurality of sizes on the component mounting surface 1004 of the wiring substrate 1002. Jetting includes meanings of ejecting, coating, pouring, and the like. By applying the ultraviolet curable-type ink to a required location on the large substrate 1100 using the ink jet head 112, a three-dimensional structure can be formed on the large substrate 1100.

### [Ultraviolet Exposure Machine]

FIGS. 4 and 5 will be referred to again for description. The ultraviolet exposure machine 114 is disposed on a side in the −Y direction of the camera 116 on the transport path of the large substrate 1100 for the transport device 102.

The ultraviolet exposure machine 114 comprises an ultraviolet light source that irradiates the entire component mounting surface of the large substrate 1100 transported by the transport device 102 with ultraviolet rays (an example of “active energy rays”) in the X direction. The ultraviolet light source is, for example, an ultraviolet lamp. The ultraviolet exposure machine 114 promotes curing of the ultraviolet curable-type ink by irradiating the ultraviolet curable-type ink applied to the large substrate 1100 by the ink jet head 112 with ultraviolet rays.

The ultraviolet rays with which the large substrate 1100 is irradiated from the ultraviolet exposure machine 114 have, for example, a wavelength of 405 nm, an irradiation intensity of 6 W/cm² on the component mounting surface of the large substrate 1100, and an irradiation width of 10 mm in the Y direction.

### [Camera]

The camera 116 is an imaging device for detecting positions and heights of the electronic components 1108 mounted on the large substrate 1100 by imaging the large substrate 1100 transported by the transport device 102. In addition, the camera 116 is an imaging device for specifying a defective nozzle 162 that does not perform jetting or performs misdirected jetting and performing quality correction such as masking processing and non-jetting correction processing by reading a test pattern printed on a test substrate such as paper. The camera 116 is, for example, a line scanner in which an imaging lens (not illustrated) and an imaging element (not illustrated) are disposed in a row at constant intervals in the X direction. The imaging lens forms the image of the reflected light, that is, the subject light, from the large substrate 1100 on an imaging plane of the imaging element. The imaging element receives the subject light of the image formed on the imaging plane and outputs the image signal of the large substrate 1100.

The camera 116 is not limited to an optical axis of the imaging lens that faces in a −Z direction and may have an optical axis of the imaging lens that is inclined in a +Y direction or the −Y direction. Accordingly, information about a height direction (Z direction) of the electronic components 1108 can be appropriately obtained. In order to obtain the information about the height direction, a distance sensor (not illustrated) may be provided in addition to the camera 116.

### [Electric Configuration]

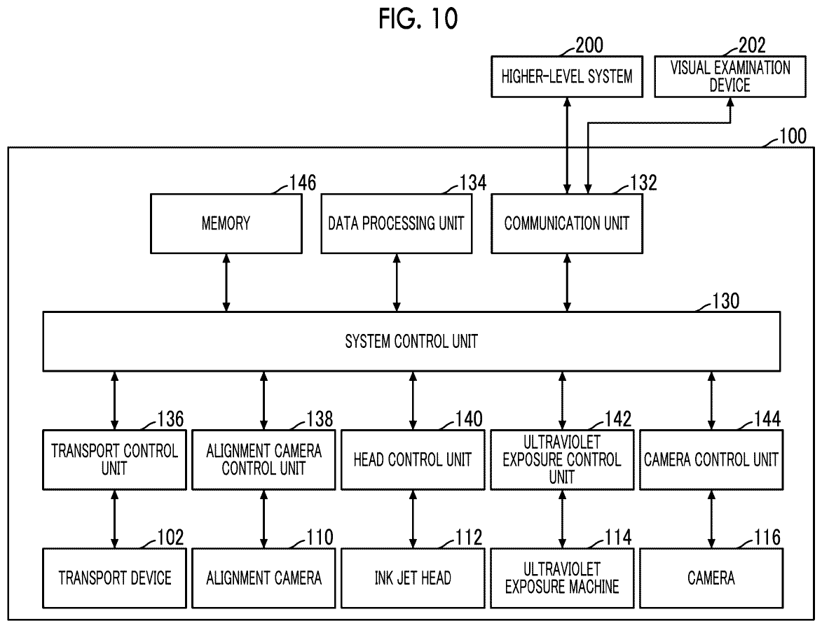

FIG. 10 is a functional block diagram illustrating an electric configuration of the ink jet printing apparatus 100. As illustrated in FIG. 10, the ink jet printing apparatus 100 comprises a system control unit 130, a communication unit 132, a data processing unit 134, a transport control unit 136, an alignment camera control unit 138, a head control unit 140, an ultraviolet exposure control unit 142, a camera control unit 144, and a memory 146.

The system control unit 130 (an example of a “control device”) controls an operation of the ink jet printing apparatus 100 in an integrated manner by transmitting instruction signals to the communication unit 132, the transport control unit 136, the alignment camera control unit 138, the head control unit 140, the ultraviolet exposure control unit 142, and the camera control unit 144.

The communication unit 132 acquires printing pattern data for forming the three-dimensional structure from a higher-level system 200 such as a host computer. In addition, the communication unit 132 acquires a result of examination from a substrate visual examination device 202.

The data processing unit 134 generates jetting data of the ink from the acquired printing pattern data. That is, the data processing unit 134 performs image processing such as halftone processing on the printing pattern data and generates the jetting data in which dot positions and dot sizes corresponding to the printing pattern data are defined. The data processing unit 134 specifies the defective nozzle 162 based on the test pattern read by the camera 116 and generates the jetting data on which the masking processing and the non-jetting correction processing are performed.

The transport control unit 136 controls an operation of the transport device 102. That is, the transport control unit 136 transports the large substrate 1100 placed on the transport stage 104.

The alignment camera control unit 138 controls an operation of the alignment camera 110. That is, the alignment camera control unit 138 causes the alignment camera 110 to image the large substrate alignment marks 1104 and the individual substrate alignment marks 1106 and acquires captured images of the large substrate alignment marks 1104 and the individual substrate alignment marks 1106.

The head control unit 140 controls an operation of the ink jet head 112. That is, the head control unit 140 controls jetting of the ultraviolet curable-type ink from the nozzles 162 of the ink jet head 112 based on the jetting data.

The ultraviolet exposure control unit 142 controls an operation of the ultraviolet exposure machine 114. That is, the ultraviolet exposure control unit 142 irradiates the ultraviolet curable-type ink applied to the large substrate 1100 by the ultraviolet exposure machine 114 with ultraviolet rays.

The camera control unit 144 controls an operation of the camera 116. That is, the camera control unit 144 causes the camera 116 to image the large substrate 1100 and acquires an image of the large substrate 1100.

The data processing unit 134 measures the position of the large substrate 1100 placed on the transport stage 104 from the captured images of the large substrate alignment marks 1104 and the individual substrate alignment marks 1106 imaged by the alignment camera 110 and deforms the printing pattern data in accordance with the measured position. The data processing unit 134 may angularly rotate the printing pattern data in a two-dimensional plane or expand and contract the printing pattern data in accordance with the measured position.

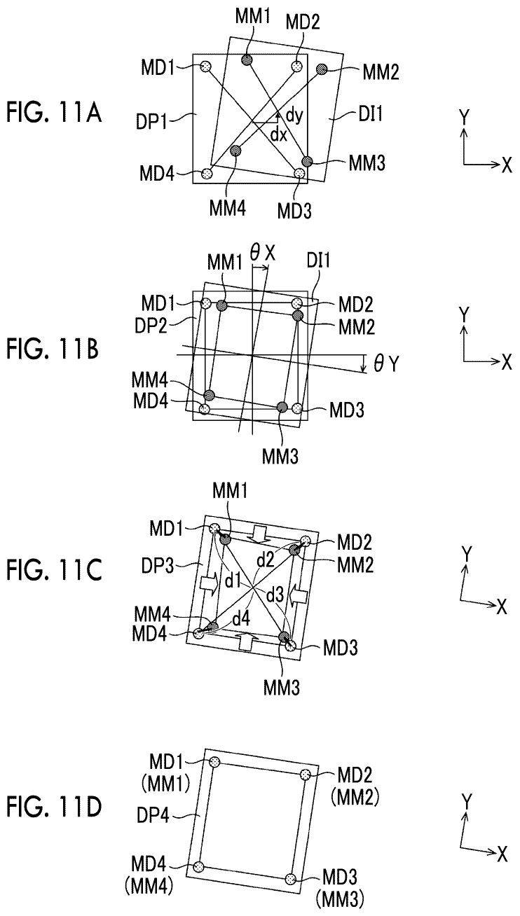

FIGS. 11A to 11D are diagrams illustrating an example of deformation of the printing pattern data using the data processing unit 134. An XY coordinate system illustrated in FIGS. 11A to 11D illustrates a design coordinate system of the printing pattern data. Here, an example of performing positioning by calculating parameters of a “centroid correction value”, a “rotation amount”, and a “magnification correction value” based on the alignment marks will be described.

FIG. 11A illustrates printing pattern data DP1 and image data DI1 of the large substrate 1100 imaged by the alignment camera 110. The image data DI1 includes four mark measurement values MM1, MM2, MM3, and MM4 corresponding to the four large substrate alignment marks 1104. In addition, the printing pattern data DP1 includes four mark design values MD1, MD2, MD3, and MD4 corresponding to positions of the four large substrate alignment marks 1104.

First, the data processing unit 134 aligns a centroid of the printing pattern data DP1 with a centroid of the image data DI1. That is, the data processing unit 134 moves the printing pattern data DP1 such that centroids of the mark design values MD1, MD2, MD3, and MD4 match centroids of the mark measurement values MM1, MM2, MM3, and MM4. In the example illustrated in FIG. 11A, a deviation amount (centroid correction value) between the centroid of the printing pattern data DP1 and the centroid of the image data DI1i is dx in the X direction and dy in the Y direction.

FIG. 11B illustrates printing pattern data DP2 and the image data DI1. The printing pattern data DP2 is data in which the printing pattern data DP1 is moved by dx in the X direction and dy in the Y direction. As illustrated in FIG. 11B, a centroid of the printing pattern data DP2 matches the centroid of the image data DI1.

Next, the data processing unit 134 rotates the printing pattern data DP2 in accordance with the image data DI1. That is, the data processing unit 134 obtains an inclination Ox between a perpendicular line passing through a center of a line connecting the mark design values MD1 and MD2 of the printing pattern data DP2 and a perpendicular line passing through a center of a line connecting the mark measurement values MM1 and MM2 of the image data DI1. In addition, the data processing unit 134 obtains an inclination Oy between a perpendicular line passing through a center of a line connecting the mark design values MD2 and MD3 of the printing pattern data DP2 and a perpendicular line passing through a center of a line connecting the mark measurement values MM2 and MM3 of the image data DI1. The data processing unit 134 sets an average of the inclination Ox and the inclination Oy as a rotation amount θ and rotates the printing pattern data DP2 by the rotation angle θ about a direction orthogonal to the X direction and to the Y direction.

FIG. 11C illustrates printing pattern data DP3 and the image data DI1. An external shape of the image data DI1 is not illustrated, and only the mark measurement values MM1, MM2, MM3, and MM4 are illustrated. The printing pattern data DP3 is data in which the printing pattern data DP2 is moved by the rotation amount θ. As illustrated in FIG. 11C, a longitudinal direction (a direction connecting the mark measurement values MM2 and MM3) and a lateral direction (a direction connecting the mark measurement values MM1 and MM2) of the image data DI1 approximately match the X direction and the Y direction of the design coordinate system of the printing pattern data.

Last, the data processing unit 134 changes a magnification of the printing pattern data DP3 in accordance with the image data DI1. That is, the data processing unit 134 calculates kx and ky (magnification correction values) such that a sum of squares of distances d1, d2, d3, and d4 between the centroids of the mark measurement values MM1, MM2, MM3, and MM4 and the mark design values MD1, MD2, MD3, and MD4, respectively, is minimized using a least squares method.

FIG. 11D illustrates printing pattern data DP4 obtained by changing the magnification of the printing pattern data DP3 by kx and ky. The printing pattern data DP4 matches the image data DI1 in position, inclination, and size. That is, the ink can be appropriately applied to the large substrate 1100 by applying the ink using the printing pattern data DP4.

Here, while an example of correcting the printing pattern data DP1 by reading the four large substrate alignment marks 1104 has been described, correction may be performed by dividing sections by reading more mark points including the four corners.

In addition, the data processing unit 134 measures sizes and positions of the electronic components 1108 mounted on the large substrate 1100 from the captured image of the large substrate 1100 imaged by the camera 116 and deforms the printing pattern data in accordance with the measured sizes and the measured positions. The data processing unit 134 may angularly rotate regions of the electronic components 1108 of the printing pattern data in a two-dimensional plane or expand and contract the regions of the electronic components 1108 of the printing pattern data in accordance with the measured sizes and the measured positions.

The memory 146 stores various types of data, various parameters, various programs, and the like used for controlling the ink jet printing apparatus 100. The system control unit 130 controls each unit of the ink jet printing apparatus 100 by applying the various parameters and the like stored in the memory 146.

### [Action]

According to the ink jet printing apparatus 100 configured as described above, the large substrate 1100 is placed on the transport stage 104 and is caused to pass below (a side in the −Z direction) the ink jet head 112 and the ultraviolet exposure machine 114. The ink jet head 112 applies the ultraviolet curable-type ink to the component mounting surface of the passing large substrate 1100, and the ultraviolet exposure machine 114 exposes the component mounting surface of the large substrate 1100 to ultraviolet rays. Accordingly, the ink can be applied to the large substrate 1100, and the applied ink can be dried and cured.

Furthermore, the ink jet printing apparatus 100 relatively moves the large substrate 1100 and the ink jet heads 112 a plurality of times. Accordingly, the ink jet printing apparatus 100 can laminate the large substrate 1100 with the ink for each relative movement.

As described above, there are various methods of drying and curing the ink, and a curing method using the ultraviolet exposure machine 114 is merely an example.

### <Acquisition of Position Information of Alignment Mark and Position Information and Height Information of Electronic Component>

While position information of the alignment marks of the large substrate 1100 and position information and height information of the electronic components 1108 may be obtained using the alignment camera 110 or the camera 116, the position information of the alignment marks of the large substrate 1100 and the position information and the height information of the electronic components 1108 are obtained in the present embodiment using the substrate visual examination device (for example, the substrate visual examination device 202 illustrated in FIG. 10) used in the substrate examination step of the manufacturing process of the printed substrate. Examples of an advantage of using the substrate visual examination device include the fact that the device is generally used in a printed substrate manufacturing process and has high measurement accuracy and a high measurement speed. In addition, the substrate visual examination device can automatically store alignment mark position information and electronic component position information that are measurement results in a data server (not illustrated).

### <Form of Electromagnetic Wave Shield>

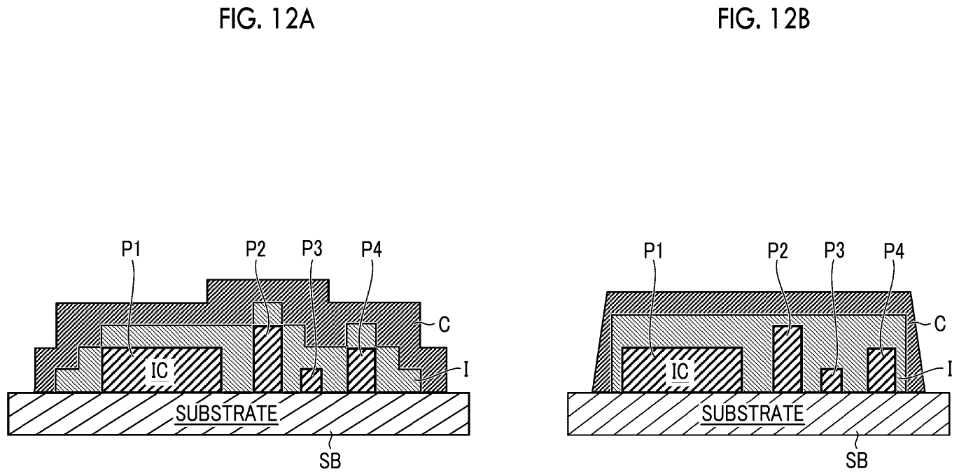

FIGS. 12A and 12B are cross-sectional views of an electromagnetic wave shield that is the three-dimensional structure created in the present embodiment. Here, the electromagnetic wave shield formed on a substrate SB having a component mounting surface on which electronic components P1, P2, P3, and P4 are mounted will be described. The substrate SB corresponds to one individual substrate 1102 laid out on the large substrate 1100 illustrated in FIGS. 3A and 3B. The electronic components P1 to P4 correspond to the electronic components 1108 illustrated in FIGS. 3A and 3B. The electronic component P1 corresponds to the IC 1006 illustrated in FIG. 1.

FIG. 12A is referred to as a conformal method. The electromagnetic wave shield of the conformal method is formed by applying an insulating ink I and a conductive ink C to the individual electronic components P1 to P4. Heights of an ink layer of the insulating ink I and an ink layer of the conductive ink C in FIG. 12A (distances in the Z direction from the mounting surface of the substrate SB to surfaces of surface layers of the ink layers) are heights corresponding to heights of the electronic components P1 to P4 (distances in the Z direction from the mounting surface of the substrate SB to top surfaces of each of the electronic components P1 to P4).

Meanwhile, FIG. 12B is referred to as an embedding method. The electromagnetic wave shield of the embedding method is formed by applying the insulating ink I to the whole of a certain region of the component mounting surface of the substrate SB to form a flat surface and applying the conductive ink C to the flat surface. The heights of the ink layer of the insulating ink I and the ink layer of the conductive ink C in FIG. 12B are constant heights regardless of the heights of the electronic components P1 to P4.

It is noted that not any of the conformal method and the embedding method is desirable over the other. The conformal method may be selected in a case of increasing productivity by reducing an ink amount as much as possible, and the embedding method may be selected in a case of providing robustness with respect to an impact on the printed substrate by securely embedding the printed substrate in the ink. In actuality, it is normally considered to use both in combination.

### <Printing Data Generation Processing in Related Art>

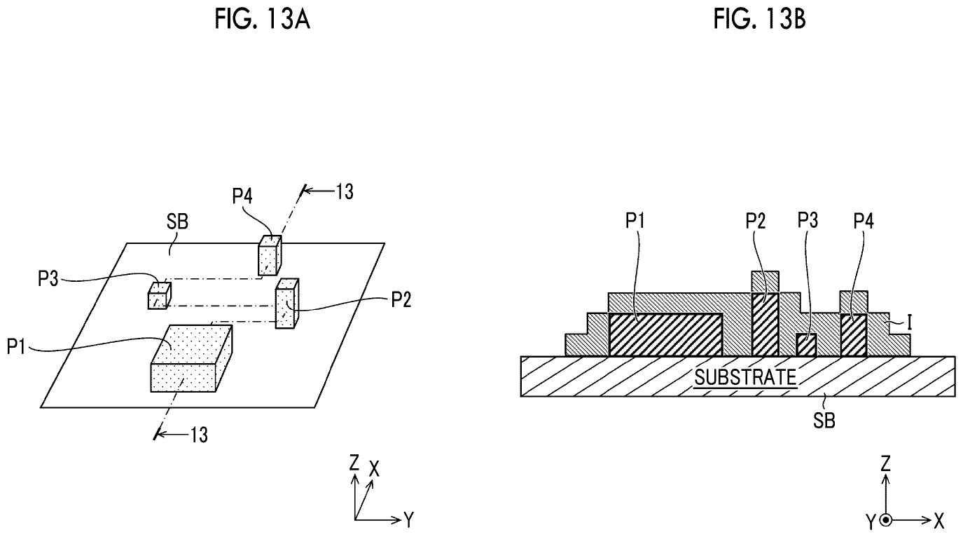

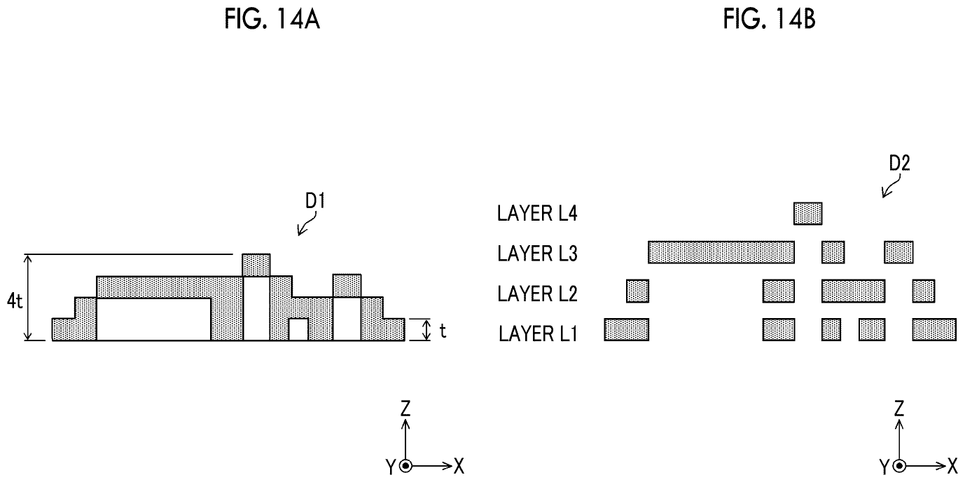

FIGS. 13A and 13B and 14A and 14B are diagrams for describing printing data generation processing in the related art. FIG. 13A illustrates the substrate SB having the component mounting surface on which the electronic components P1 to P4 are mounted. In addition, FIG. 13B illustrates a 13-13 cross section in a state where the ink layer of the insulating ink I is formed on the component mounting surface of the substrate SB. Here, an example of stacking the ink by printing each corresponding layer from a lower layer as in a three-dimensions (3D) printer in applying the insulating ink I to the component mounting surface of the substrate SB will be described.

FIG. 14A is three-dimensional structure data D1 indicating a three-dimensional structure of the insulating ink I. In addition, FIG. 14B is printing data D2 consisting of a plurality of pieces of slice data obtained by layering the three-dimensional structure data D1 through slicing processing. The slicing processing means dividing target three-dimensional structure data into two-dimensional images for each printing performed once. Here, each divided two-dimensional image will be referred to as a slice image, and data of the slice image will be referred to as slice data.

It is assumed that the height, in a lamination direction (Z direction), of the ink layer that can be formed by performing printing once is t, and the maximum height of the three-dimensional structure data D1 in the lamination direction is 4t. In a case where the three-dimensional structure data D1 having the maximum height 4t is subjected to the slicing processing with the height t, the three-dimensional structure data D1 is divided into slice data of total four layers including slice data of a layer L1, slice data of a layer L2, slice data of a layer L3, and slice data of a layer L4, as illustrated in FIG. 14B. That is, the printing data D2 includes four pieces of slice data.

The slice data may be referred to as a relatively lower layer as the slice data comes closer to the substrate in the lamination direction, and may be referred to as a relatively upper layer as the slice data is separated from the substrate in the lamination direction. That is, in the printing data D2, the slice data of the layer L1 is the lowermost layer, and the slice data of the layer L4 is the uppermost layer. In addition, in a case where N is an integer, the slice data may be referred to as an N-th layer in order from the lower layer. That is, in the printing data D2, the slice data of the layer L1 is a first layer, the slice data of the layer L2 is a second layer, the slice data of the layer L3 is a third layer, and the slice data of the layer L4 is a fourth layer.

The ink jet printing apparatus 100 can form the ink layer of the insulating ink I by performing printing using the jetting data based on the slice data of the layer L1, printing using the jetting data based on the slice data of the layer L2, printing using the jetting data based on the slice data of the layer L3, and printing using the jetting data based on the slice data of the layer L4 in this order. That is, in the related art, forming the ink layer of the insulating ink I illustrated in FIG. 14A on the surface of the substrate SB inevitably requires performing printing four times.

### First Embodiment

### [Printing Data Generation Device]

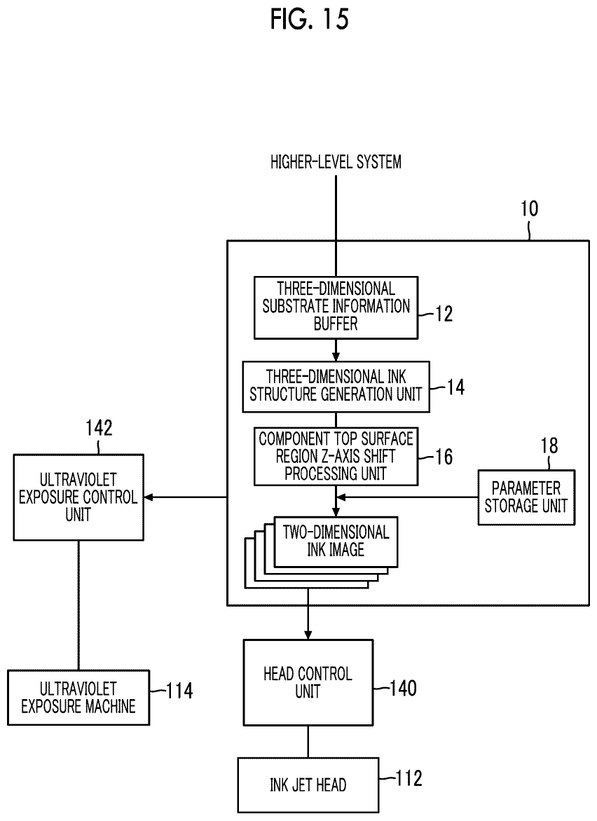

FIG. 15 is a block diagram of a printing data generation device 10 according to a first embodiment. The printing data generation device 10 is composed of a processor. The processor executes an instruction stored in a memory. A hardware structure of the processor corresponds to various processors illustrated as follows. The various processors include a central processing unit (CPU) that is a general-purpose processor acting as various functional units by executing software (program), a graphics processing unit (GPU) that is a processor specialized in image processing, a programmable logic device (PLD) such as a field programmable gate array (FPGA) that is a processor having a circuit configuration changeable after manufacture, a dedicated electric circuit such as an application specific integrated circuit (ASIC) that is a processor having a circuit configuration dedicatedly designed to execute specific processing, and the like.

One processing unit may be composed of one of the various processors or may be composed of two or more processors of the same type or different types (for example, a plurality of FPGAs, a combination of a CPU and an FPGA, or a combination of a CPU and a GPU). In addition, a plurality of functional units may be composed of one processor. Examples of the plurality of functional units composed of one processor include, first, as represented by a computer such as a client or a server, a form of one processor composed of a combination of one or more CPUs and software, in which the processor acts as the plurality of functional units. Second, as represented by a system on chip (SoC) or the like, a form of using a processor that implements functions of the whole system including the plurality of functional units in one integrated circuit (IC) chip is included. Various functional units are configured using one or more of the various processors as a hardware structure.

Furthermore, the hardware structure of the various processors is more specifically an electric circuit (circuitry) in which circuit elements such as semiconductor elements are combined.

The memory stores the instruction to be executed by the processor. The memory includes a random access memory (RAM) and a read only memory (ROM). The processor executes software using the RAM as a work region and using various programs including a printing data generation program and parameters stored in the ROM and executes various types of processing of the printing data generation device using the parameters stored in the ROM or the like.

The printing data generation device 10 may be configured as a device separated from the ink jet printing apparatus 100 or may be included in the system control unit 130 of the ink jet printing apparatus 100. The printing data generation device 10 and the ink jet printing apparatus 100 may constitute a printing system. As illustrated in FIG. 15, the printing data generation device 10 comprises a three-dimensional substrate information buffer 12, a three-dimensional ink structure generation unit 14, a component top surface region Z-axis shift processing unit 16, and a parameter storage unit 18.

The printing data generation device 10 acquires three-dimensional structure information of the substrate (for example, the printed substrate) for forming the three-dimensional structure from a higher-level system (for example, the higher-level system 200 illustrated in FIG. 10). The three-dimensional substrate information buffer 12 stores the three-dimensional structure information of the substrate. The three-dimensional ink structure generation unit 14 generates three-dimensional ink structure data based on the three-dimensional structure information of the substrate. The component top surface region Z-axis shift processing unit 16 generates post-shift processing three-dimensional ink structure data by performing shifting processing (described later) on the three-dimensional ink structure data.

The parameter storage unit 18 records parameters for the slicing processing. The parameters for the slicing processing include an ink thickness (a height in the lamination direction), a printing resolution, an ink droplet volume, and the like per printing performed once. The parameters stored in the parameter storage unit 18 may be input into the printing data generation device 10 from the higher-level system or, since the parameters are information depending on the head control unit 140, may be acquired from the head control unit 140.

The printing data generation device 10 generates the printing data including the plurality of pieces of slice data for each layer by performing the slicing processing on the post-shift processing three-dimensional ink structure data based on the parameters.

The printing data generation device 10 may control the head control unit 140 and the ultraviolet exposure control unit 142 based on the generated printing data.

### [Printing Data Generation Method]

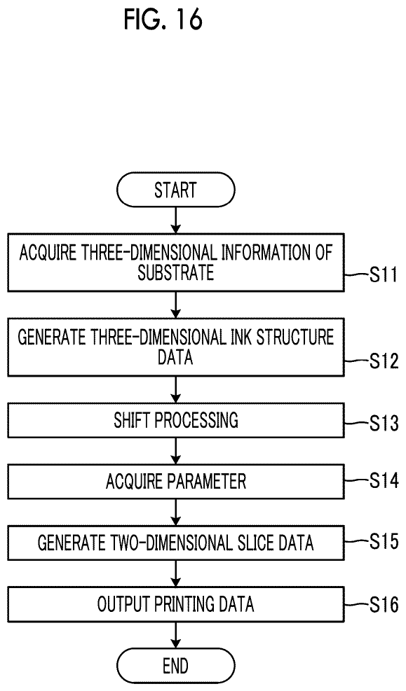

FIG. 16 is a flowchart illustrating processing of a printing data generation method via the printing data generation device 10 according to the first embodiment. The printing data generation method is implemented by executing the printing data generation program stored in the memory via the processor. The printing data generation program may be provided by a computer-readable non-transitory storage medium or may be provided through the Internet.

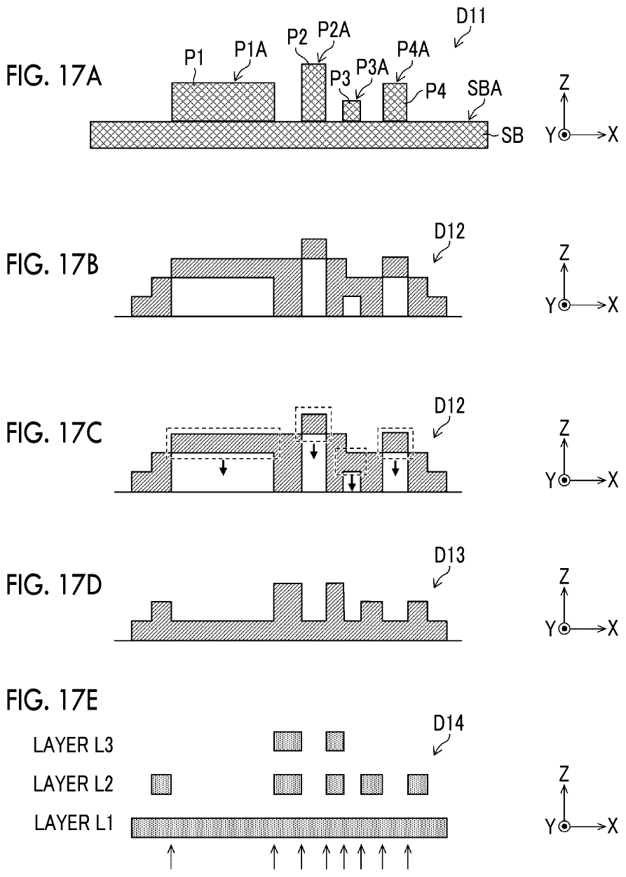

In addition, FIGS. 17A to 17E are diagrams for describing data processing using the printing data generation method according to the first embodiment. Here, an example of forming the ink layer of the insulating ink illustrated in FIG. 13B will be described.

In step S11, the printing data generation device 10 acquires the three-dimensional structure information of the substrate SB from the higher-level system and stores the three-dimensional structure information in the three-dimensional substrate information buffer 12.

FIG. 17A illustrates an example of three-dimensional structure information D11. Here, the three-dimensional structure information D11 is information about the substrate SB on which the electronic components P1 to P4 are mounted (an example of “installed”) and includes information about a protruding and recessed surface including a component mounting surface SBA (an example of an “installation surface”) of the substrate SB, a top surface P1A of the electronic component P1, a top surface P2A of the electronic component P2, a top surface P3A of the electronic component P3, and a top surface P4A of the electronic component P4 (examples of a “component top surface”). The information about the protruding and recessed surface includes the position information of the alignment marks (not illustrated) acquired by the substrate visual examination device and the position information and the height information of the electronic components P1 to P4.

The top surface of the electronic component is a surface facing in a direction (Z direction) orthogonal to the component mounting surface SBA among outer surfaces of the electronic component. The top surface of the electronic component faces the nozzle surface 148 of the ink jet head 112 in applying the insulating ink to the substrate SB using the ink jet printing apparatus 100 and is laminated with the ink. Here, while each of the top surfaces P1A to P4A of the electronic components P1 to P4 is a flat surface parallel to the component mounting surface SBA, the top surface is not limited to a flat surface. The top surface includes a surface that is not parallel to the component mounting surface of the substrate.

In step S12 (an example of an “acquisition step”), the three-dimensional ink structure generation unit 14 generates the three-dimensional ink structure data (an example of “three-dimensional data”) of the three-dimensional structure to be formed using the insulating ink, based on the three-dimensional structure information D11 of the substrate SB acquired in step S11. The three-dimensional ink structure data may be input from the higher-level system. FIG. 17B illustrates three-dimensional ink structure data D12 generated from the three-dimensional structure information D11. The three-dimensional ink structure data D12 is data in which a region of an upper surface has a height corresponding to the heights of the electronic components P1 to P4.

In step S13 (an example of a “processing step”), the component top surface region Z-axis shift processing unit 16 generates post-shift processing three-dimensional ink structure data D13 by performing the shift processing (an example of “first shift processing”) of shifting a region of the top surface of the electronic component in the lamination direction to the lamination direction on the three-dimensional ink structure data D12 generated in step S12.

FIG. 17C illustrates regions of the top surfaces P1A to P4A of the electronic components P1 to P4 in the lamination direction in the three-dimensional ink structure data D12 by surrounding the regions with a broken line. In addition, FIG. 17D illustrates the post-shift processing three-dimensional ink structure data D13. As illustrated in FIG. 17C and FIG. 17D, the component top surface region Z-axis shift processing unit 16 generates the post-shift processing three-dimensional ink structure data D13 by shifting the regions of the top surfaces P1A to P4A in the lamination direction in the three-dimensional ink structure data D12 to the lamination direction until positions (heights) touching the top surfaces P1A to P4A reach positions (heights) touching the substrate SB. That is, the shift processing is processing of joining the positions touching the top surfaces P1A to P4A of the three-dimensional ink structure data D12 to the positions touching the component mounting surface SBA.

In step S14, the printing data generation device 10 acquires the parameters for the slicing processing from the parameter storage unit 18.

In step S15 (an example of a “conversion step”), the printing data generation device 10 generates printing data D14 including a slice image for each layer by performing the slicing processing on the post-shift processing three-dimensional ink structure data D13 based on the parameters acquired in step S14. Here, the printing data generation device 10 converts the post-shift processing three-dimensional ink structure data D13 into the printing data D14 including a plurality of pieces of slice data (an example of “two-dimensional slice data”) in a lamination order by dividing the post-shift processing three-dimensional ink structure data D13 in a direction parallel to a plane direction.

In step S16, the printing data generation device 10 outputs the printing data D14 to the ink jet printing apparatus 100.

FIG. 17E illustrates the printing data D14. Here, the printing data D14 includes the slice data of three layers including the layers L1, L2, and L3.

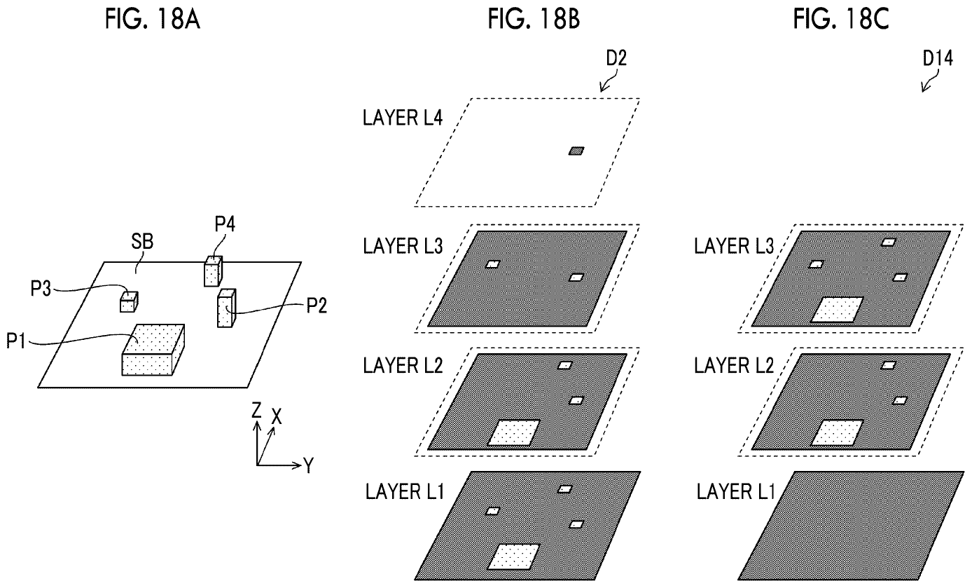

FIGS. 18A to 18C are diagrams for describing reduction of the number of layers according to the first embodiment. FIG. 18A is a perspective view of the substrate SB forming the three-dimensional structure in the first embodiment. FIG. 18B is the printing data for the substrate SB generated through the printing data generation processing in the related art and illustrates the same printing data D2 as FIG. 14B. In addition, FIG. 18C is the printing data for the substrate SB generated according to the first embodiment and illustrates the same printing data D14 as FIG. 17E. As illustrated in FIG. 18B and FIG. 18C, in the first embodiment, the number of layers of the slice data can be reduced by performing the slicing processing after the shift processing.

The ink jet printing apparatus 100 forms the electromagnetic wave shield on the substrate SB using the printing data D14 generated as described above (an example of a “manufacturing method of a three-dimensional structure”). That is, the printing data D14 is input into the ink jet printing apparatus 100, and the ink jet printing apparatus 100 generates each jetting data from each slice data of the layers L1, L2, and L3 of the printing data D14 using the data processing unit 134. The jetting data may be generated using the printing data generation device 10.

Furthermore, the ink jet printing apparatus 100 applies the insulating ink to the substrate SB in an order of the layers L1, L2, and L3 based on the jetting data. That is, the ink jet printing apparatus 100 relatively moves the transport stage 104 on which the substrate SB is placed and the ink jet head 112, applies the insulating ink to the substrate SB based on the jetting data of the layer L1 during the relative movement performed for the first time, applies the insulating ink to the substrate SB based on the jetting data of the layer L2 during the relative movement performed for the second time, and applies the insulating ink to the substrate SB based on the jetting data of the layer L3 during the relative movement performed for the third time (an example of a “lamination step”). In addition, during each relative movement, the ultraviolet exposure machine 114 promotes curing of the insulating ink by irradiating the insulating ink with ultraviolet rays.

As described above, the ink jet printing apparatus 100 can reduce the number of layers and form the ink layer of the insulating ink I illustrated in FIG. 14A on the surface of the substrate SB by performing printing three times. In addition, since an ink amount of the lower layer is increased through the shift processing, the ink applied first can be irradiated with ultraviolet rays in subsequent printing. Thus, a total ink amount can be irradiated with more ultraviolet rays, and improvement in productivity is expected. In addition, bubbles are unlikely to stay in an edge part of a structure such as the electronic components P1 to P4.

It is preferable that the ink jet printing apparatus 100 reduces an irradiation amount of the ultraviolet rays in the relative movement performed for the first time (an example of “initial relative movement”) relative to an irradiation amount of the ultraviolet rays in the relative movement performed for a second time or later. For example, the irradiation amount of the ultraviolet rays in the relative movement performed for the first time is 1 to 5 mJ/cm2, and the irradiation amount of the ultraviolet rays in the relative movement performed for the second time or later is 10 mJ/cm2. Controlling the irradiation amount of the ultraviolet rays as described above facilitates spreading of the ink applied to the component mounting surface SBA. Thus, the ink can be spread to side surfaces and lower portions of the electronic components P1 to P4.

The electromagnetic wave shield can be formed on the component mounting surface of the substrate SB as illustrated in FIG. 12A by depositing the conductive ink to further form the ink layer of the conductive ink after forming the ink layer of the insulating ink. The slicing processing and the shift processing can also be applied to a case of generating the printing data for forming the ink layer of the conductive ink.

### [Adjustment of Printing Data]

It is preferable that the printing data generation device 10 provides a gap in regions of edge parts of the top surfaces P1A to P4A in generating the printing data D14. The regions of the edge parts of the top surfaces P1A to P4A are, for example, regions illustrated by arrows in FIG. 17E. By forming the ink layer using the printing data D14, bleeding of the ink is not formed in the edge parts of the top surfaces P1A to P4A, and the ink up to the lower portions (in a direction closer to the component mounting surface SBA than the top surfaces P1A to P4A in the lamination direction) is irradiated with ultraviolet rays.

In addition, it is preferable that the printing data generation device 10 reduces a jetting amount of the ink for regions touching the side surfaces of the electronic components P1 to P4 in generating the printing data D14. By forming the ink layer using the printing data D14, lamination with the ink is not required to be performed to the heights of the electronic components P1 to P4 in the lamination direction, and productivity is improved. The regions touching the side surfaces of the electronic components P1 to P4 are, for example, the regions illustrated by the arrows in FIG. 17E. For example, the regions touching the side surfaces of the electronic components P1 to P4 may not be required in the slice data of the layer L3, and the regions touching the side surfaces of the electronic components P1 to P4 may also not be required in the slice data of the layer L2.

### Second Embodiment

### [Printing Data Generation Device]

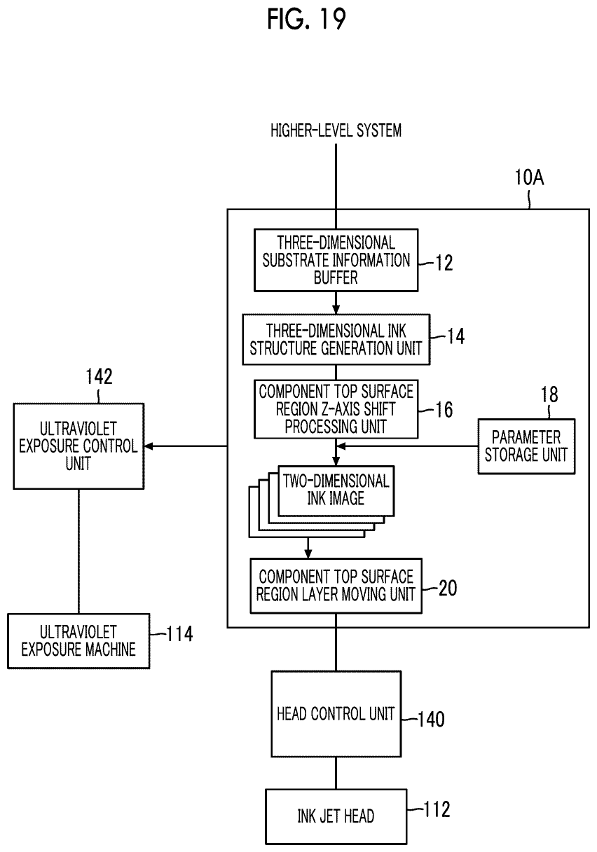

FIG. 19 is a block diagram of a printing data generation device according to a second embodiment. Parts common to FIG. 15 will be designated by the same reference numerals and will not be described in detail. As illustrated in FIG. 19, a printing data generation device 10A comprises a component top surface region layer moving unit 20. The component top surface region layer moving unit 20 generates printing data including post-shift processing slice data for each layer by performing shift processing (described later) on input slice data for each layer.

### [Printing Data Generation Method]

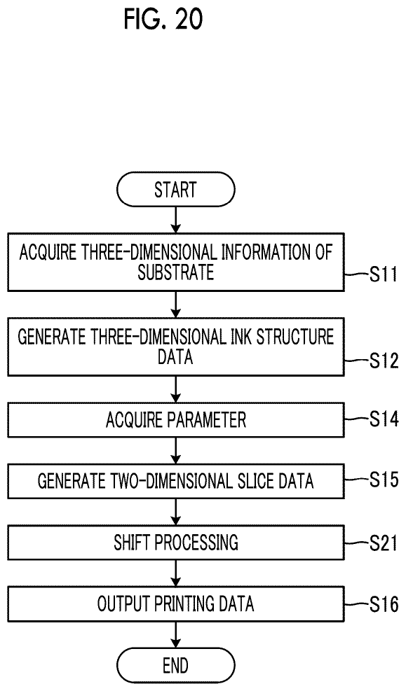

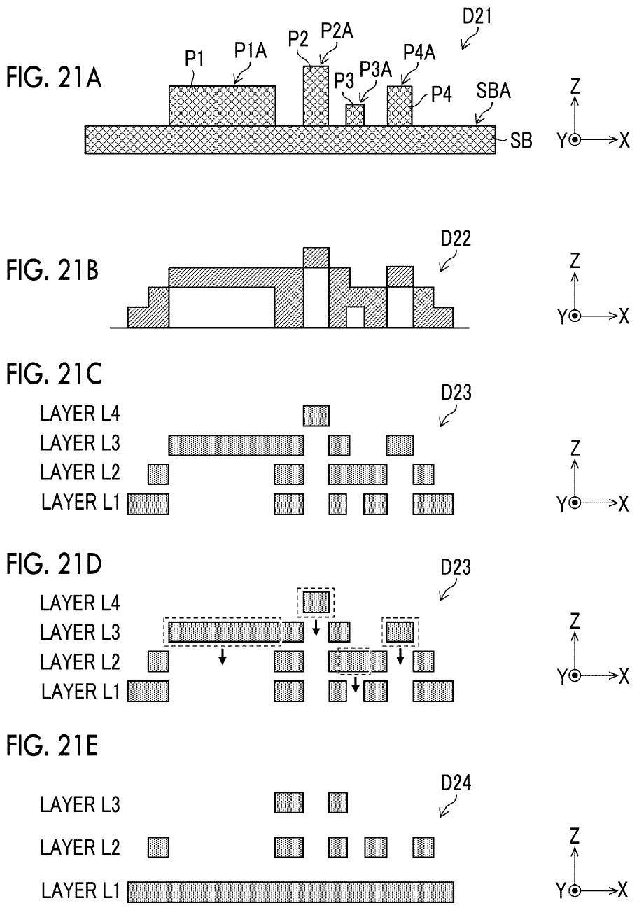

FIG. 20 is a flowchart illustrating processing of a printing data generation method via the printing data generation device 10A according to the second embodiment. Parts common to FIG. 16 will be designated by the same reference numerals and will not be described in detail. In addition, FIGS. 21A to 21E are diagrams for describing data processing using the printing data generation method according to the second embodiment. The same example of forming the ink layer of the insulating ink illustrated in FIG. 13B as in the first embodiment will be described.

In step S11, the printing data generation device 10A acquires the three-dimensional structure information of the substrate SB. FIG. 21A illustrates an example of three-dimensional structure information D21 acquired in step S11. The three-dimensional structure information D21 is the same as the three-dimensional structure information D11 illustrated in FIG. 16A.

In step S12, the three-dimensional ink structure generation unit 14 generates the three-dimensional ink structure data of the three-dimensional structure to be formed using the insulating ink. FIG. 21B illustrates three-dimensional ink structure data D22 generated from the three-dimensional structure information D21. The three-dimensional ink structure data D22 is the same as the three-dimensional ink structure data D12 illustrated in FIG. 17B.

Next, in step S14, the printing data generation device 10A acquires the parameters for the slicing processing from the parameter storage unit 18.

In step S15, the printing data generation device 10A generates a slice data group D23 including the slice data for each layer by performing the slicing processing on the three-dimensional ink structure data D22 generated in step S12 based on the parameters acquired in step S14. Here, the printing data generation device 10A converts the three-dimensional ink structure data D22 into the slice data group D23 including a plurality of pieces of slice data in the lamination order by dividing the three-dimensional ink structure data D22 in the direction parallel to the plane direction.

FIG. 21C illustrates the slice data group D23. Here, the slice data group D23 includes the slice data of four layers including the layers L1, L2, L3, and L4.

In step S21 (an example of the “processing step”), the component top surface region layer moving unit 20 generates a post-shift processing slice data group D24 by performing the shift processing (an example of “second shift processing”) of shifting the regions of the top surfaces of the electronic components in the lamination direction to different layers in the lamination direction on the slice data group D23 generated in step S15.

FIG. 21D illustrates the regions of the top surfaces PiA to P4A of the electronic components P1 to P4 in the lamination direction in the slice data group D23 by surrounding the regions with a broken line. In addition, FIG. 21E illustrates the post-shift processing slice data group D24. As illustrated in FIG. 21D and FIG. 21E, the component top surface region layer moving unit 20 generates the post-shift processing slice data group D24 by shifting the layers in the lamination direction for the regions of the top surfaces PiA to P4A in the slice data of each layer of the slice data group D23 to the lamination direction until the positions (heights) touching the top surfaces P1A to P4A reach the positions (heights) touching the substrate SB.

That is, in a case where M and N are integers satisfying M≤N, slice data of the lowermost layer touching the component mounting surface SBA among the plurality of pieces of slice data is referred to as slice data of a first layer, slice data of a layer touching the top surfaces PIA to P4A is referred to as slice data of an M-th layer, and two-dimensional slice data of the uppermost layer in the lamination direction is referred to as two-dimensional slice data of an N-th layer, the shift processing is processing of joining the regions of the top surfaces P1A to P4A in the lamination direction in the slice data of the M-th layer to the N-th layer to the first layer to an (N−M+1)-th layer, respectively.

Last, in step S16, the printing data generation device 10A outputs the post-shift processing slice data group D24 to the ink jet printing apparatus 100 as the printing data.

As described above, the shift processing may be performed after the slicing processing. In the second embodiment, the number of layers of the slice data can be reduced by performing the shift processing after the slicing processing.

An example of forming the ink layer in the electromagnetic wave shield of the conformal method has been described so far. However, in a case where the ink layer in the electromagnetic wave shield of the embedding method is formed, and the shift processing of the first embodiment or the shift processing of the second embodiment is applied, the lamination order (printing order) of the layers is actually reversed upside down in the shift processing.

In this case, since the total number of layers is not decreased, productivity of printing is not improved. However, since the ink amount of the lower layer is increased, the total ink amount can be irradiated with more ultraviolet rays. Thus, improvement in productivity of the system is expected.

### Third Embodiment

### [Printing Data Generation Device]

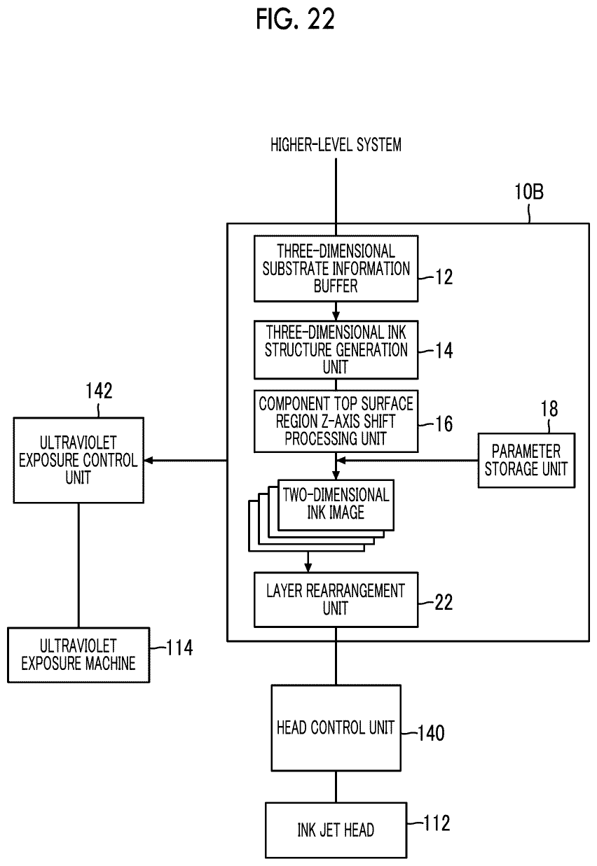

FIG. 22 is a block diagram of a printing data generation device according to a third embodiment. Parts common to FIG. 19 will be designated by the same reference numerals and will not be described in detail. As illustrated in FIG. 22, a printing data generation device 10B comprises a layer rearrangement unit 22. The layer rearrangement unit 22 generates printing data including post-layer rearrangement slice data for each layer by performing layer rearrangement processing (described later) on the input slice data for each layer.

### [Printing Data Generation Method]

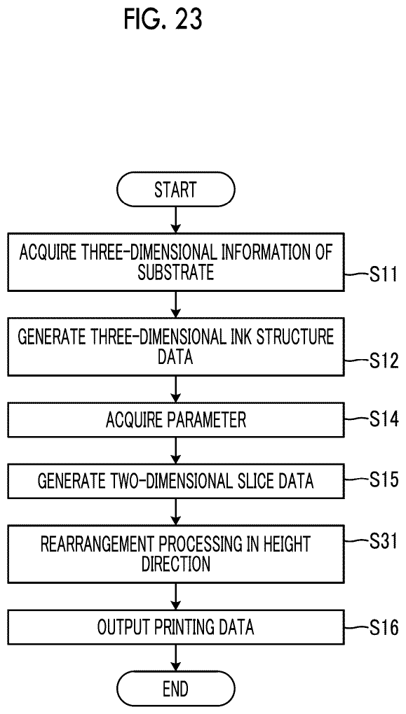

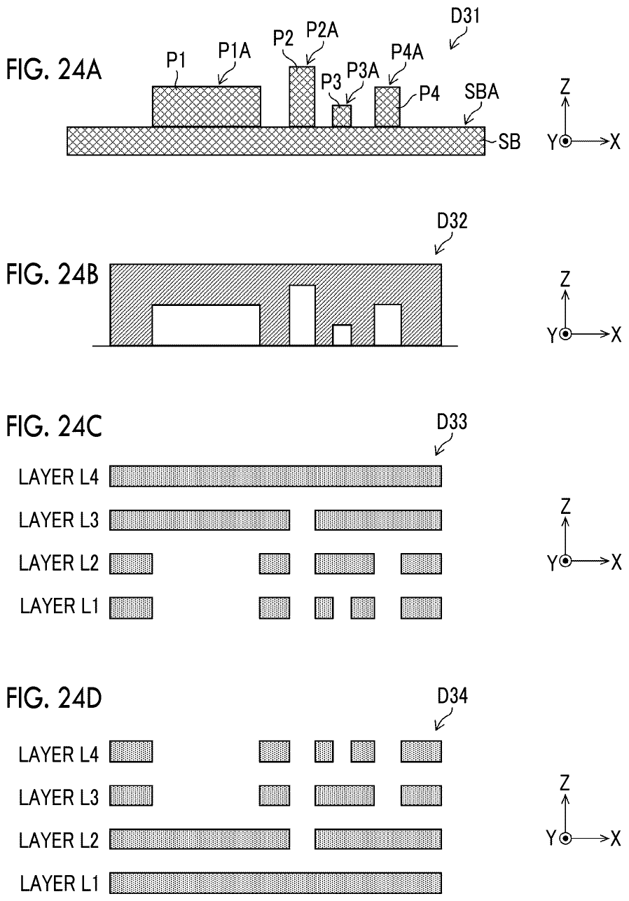

FIG. 23 is a flowchart illustrating processing of a printing data generation method via the printing data generation device 10B according to the third embodiment. Parts common to FIG. 19 will be designated by the same reference numerals and will not be described in detail. In addition, FIGS. 24A to 24D are diagrams for describing data processing using the printing data generation method according to the third embodiment. Here, an example of forming the ink layer of the insulating ink illustrated in FIG. 12B will be described. As illustrated in FIG. 12B, an upper surface of the ink layer of the insulating ink in the electromagnetic wave shield of the embedding method is formed as a flat surface.

In step S11, the printing data generation device 10B acquires the three-dimensional structure information of the substrate SB from the higher-level system. FIG. 24A illustrates an example of three-dimensional structure information D31 acquired in step S11. The three-dimensional structure information D31 is the same as the three-dimensional structure information D21 illustrated in FIG. 21A.

In step S12, the three-dimensional ink structure generation unit 14 generates the three-dimensional ink structure data of the three-dimensional structure to be formed using the insulating ink, based on the three-dimensional structure information of the substrate SB acquired in step S11. FIG. 24B illustrates three-dimensional ink structure data D32 generated from the three-dimensional structure information D31. The three-dimensional ink structure data D32 is data in which the region of the upper surface is formed as a flat surface regardless of the heights of the electronic components P1 to P4.

Next, in step S14, the printing data generation device 10 acquires the parameters for the slicing processing from the parameter storage unit 18.

In step S15, the printing data generation device 10 generates a slice data group D33 including a slice image for each layer by performing the slicing processing on the three-dimensional ink structure data D32 based on the parameters acquired in step S14. Here, the printing data generation device 10 converts the three-dimensional ink structure data D32 into the slice data group D33 including a plurality of pieces of slice data in the lamination order by dividing the three-dimensional ink structure data D32 in the direction parallel to the plane direction.

FIG. 24C illustrates the slice data group D33. Here, the slice data group D33 includes the slice data of four layers including the layers L1, L2, L3, and L4.

In step S31 (an example of the “processing step”), the layer rearrangement unit 22 performs rearrangement processing of rearranging the lamination order of the plurality of pieces of slice data. Here, the layer rearrangement unit 22 generates a slice data group D34 in which the lamination order of the slice data group D33 is rearranged.

FIG. 24D illustrates the slice data group D34 generated from the slice data group D33. Here, the slice data of the layers including the layers L1, L2, L3, and L4 in the slice data group D34 is the slice data of the layers including the layers L4, L3, L2, and L1 in the slice data group D33, respectively.

That is, in a case where N is an integer, the plurality of pieces of two-dimensional slice data include two-dimensional slice data of the first layer that is the lowermost layer touching the installation surface to two-dimensional slice data of the N-th layer that is two-dimensional slice data of the uppermost layer in the lamination direction, and the rearrangement processing is processing of converting the slice data of the first layer to the N-th layer into slice data of the N-th layer to the first layer for the plurality of pieces of slice data.

As described above, in a case of forming the ink layer of the insulating ink in forming the electromagnetic wave shield of the embedding method, the ink amount of the lower layer is increased through the rearrangement processing of rearranging the lamination order of the plurality of pieces of slice data, and the total ink amount can be irradiated with more ultraviolet rays. Thus, improvement in the productivity of the system is expected.

### <Other>

Generation of the printing data for forming the three-dimensional structure of the liquid on the protruding and recessed surface including the component mounting surface of the substrate having the component top surface and the component mounting surface on which the component is mounted has been described so far. However, a target for forming the three-dimensional structure is not limited to a substrate. The present invention can be applied to generation of the printing data for forming the three-dimensional structure of the liquid by laminating, with the liquid, the protruding and recessed surface of the target comprising the protruding and recessed surface having a protrusion and a recess in the lamination direction in which lamination with the liquid is performed.

The technical scope of the present invention is not limited to the scope according to the embodiments. The configurations and the like in each embodiment can be appropriately combined between the embodiments without departing from the gist of the present invention.

### EXPLANATION OF REFERENCES

10, 10A, 10B: printing data generation device
12: three-dimensional substrate information buffer
14: three-dimensional ink structure generation unit
16: component top surface region Z-axis shift processing unit
18: parameter storage unit
20: component top surface region layer moving unit
22: layer rearrangement unit
100: ink jet printing apparatus
102: transport device
104: transport stage
106: moving mechanism
110 alignment camera
112: ink jet head
114: ultraviolet exposure machine
116: camera
118: pedestal
130: system control unit
132: communication unit
134: data processing unit
136: transport control unit
138: alignment camera control unit
140: head control unit
142: ultraviolet exposure control unit
144: camera control unit
146: memory
148: nozzle surface
148-i: nozzle surface
150-i: head module
152: support frame
154: cable
156: dummy plate
156A: surface
158-i: nozzle disposition unit
160: nozzle array
162: nozzle
164: ejector
166: pressure chamber
168: piezoelectric element
170: nozzle flow channel
172: individual supply path
174: supply-side common branch flow channel
176: vibration plate
178: individual electrode
180: piezoelectric body
182: cover plate
184: movable space
200: higher-level system
202: substrate visual examination device
1000: electric component mounting substrate
1002: wiring substrate
1004: component mounting surface
1005: alignment mark
1008: resistor
1008A: resistor array
1009: electrode
1010: capacitor
1020: conductive pattern
1022: insulating coating
1100: large substrate
1102: individual substrate
1104: large substrate alignment mark
1106: individual substrate alignment mark
1108: electronic component
C: conductive ink
D1: three-dimensional structure data
D2: printing data
D11: three-dimensional structure information
D12: three-dimensional ink structure data
D13: post-shift processing three-dimensional ink structure data
D14: printing data
D21: three-dimensional structure information
D22: three-dimensional ink structure data
D23: slice data group
D24: post-shift processing slice data group
D31: three-dimensional structure information
D32: three-dimensional ink structure data
D33: slice data group
D34: slice data group
DI1: image data
DP1, DP2, DP3, DP4: printing pattern data
I: insulating ink
L1, L2, L3, L4: layer
MD1, MD2, MD3, MD4: mark design value
MM1, MM2, MM3, MM4: mark measurement value
P1, P2, P3, P4: electronic component
P1A, P2A, P3A, P4A: top surface
SB: substrate
SBA: component mounting surface
S1 to S6: step of manufacturing process of printed substrate
S11 to S16, S21, S31: step of printing data generation method

What is claimed is:

1. A printing data generation device that generates printing data of a printing apparatus which forms a three-dimensional structure of a liquid by applying, based on the printing data, the liquid to a protruding and recessed surface including a component top surface and an installation surface of a substrate having the installation surface on which a component is installed, the printing apparatus including a liquid jetting head including a nozzle that jets a liquid, a relative moving mechanism that relatively moves the liquid jetting head and the substrate in a direction parallel to the installation surface, and a control device that laminates the protruding and recessed surface with the liquid for each relative movement by jetting the liquid to the protruding and recessed surface of the substrate from the nozzle based on the printing data,
the printing data generation device comprising:
at least one processor; and
at least one memory that stores an instruction to be executed by the at least one processor,
wherein the at least one processor is configured to:
acquire three-dimensional data of the three-dimensional structure to be formed using the liquid;
convert the three-dimensional data into a plurality of pieces of two-dimensional slice data in a lamination order by dividing the three-dimensional data in the direction parallel to the installation surface; and
perform any of first shift processing of shifting data of a region of the component top surface in a lamination direction of the liquid in the three-dimensional data to the lamination direction, second shift processing of shifting the data of the region of the component top surface in the lamination direction in the plurality of pieces of two-dimensional slice data to the lamination direction, or rearrangement processing of rearranging the lamination order of the plurality of pieces of two-dimensional slice data.

2. The printing data generation device according to claim 1,
wherein the first shift processing is processing of joining a position touching the component top surface to a position touching the installation surface in the three-dimensional data.

3. The printing data generation device according to claim 1,
wherein in a case where M and N are integers satisfying M≤N, two-dimensional slice data of a lowest layer touching the installation surface among the plurality of pieces of two-dimensional slice data is referred to as two-dimensional slice data of a first layer, two-dimensional slice data of a layer touching the component top surface is referred to as two-dimensional slice data of an M-th layer, and two-dimensional slice data of an uppermost layer in the lamination direction is referred to as two-dimensional slice data of an N-th layer, the second shift processing is processing of joining the region of the component top surface in the lamination direction in the two-dimensional slice data of the M-th layer to the N-th layer to the first layer to an (N−M+1)-th layer, respectively.

4. The printing data generation device according to claim 1,
wherein in a case where N is an integer, the plurality of pieces of two-dimensional slice data include two-dimensional slice data of a first layer that is a lowermost layer touching the installation surface to two-dimensional slice data of an N-th layer that is two-dimensional slice data of an uppermost layer in the lamination direction, and
the rearrangement processing is processing of converting the two-dimensional slice data of the first layer to the N-th layer into two-dimensional slice data of the N-th layer to the first layer, respectively, in the plurality of pieces of two-dimensional slice data.

5. The printing data generation device according to claim 1,
wherein the at least one processor is configured to convert the three-dimensional data into the two-dimensional slice data by providing a gap in a region of an edge part of the component top surface.

6. The printing data generation device according to claim 1,
wherein the at least one processor is configured to convert the three-dimensional data into the two-dimensional slice data by reducing a jetting amount of the liquid in a region touching a side surface of the component.

7. The printing data generation device according to claim 1,
wherein the at least one processor is configured to generate the three-dimensional data based on information about the protruding and recessed surface.

8. The printing data generation device according to claim 7,
wherein the at least one processor is configured to acquire the information about the protruding and recessed surface based on an image obtained by imaging the substrate having the installation surface on which the component is installed via a camera.

9. The printing data generation device according to claim 1,
wherein the at least one processor is configured to convert the three-dimensional data into a plurality of pieces of two-dimensional slice data by dividing the three-dimensional data by a height of an ink layer in the lamination direction formed by the relative movement performed once.

10. A printing system comprising:
a printing apparatus which forms a three-dimensional structure of a liquid by applying, based on printing data, the liquid to a protruding and recessed surface including a component top surface and an installation surface of a substrate having the installation surface on which a component is installed, the printing apparatus including a liquid jetting head including a nozzle that jets a liquid, a relative moving mechanism that relatively moves the liquid jetting head and the substrate in a direction parallel to the installation surface, and a control device that laminates the protruding and recessed surface with the liquid for each relative movement by jetting the liquid to the protruding and recessed surface of the substrate from the nozzle based on the printing data; and
the printing data generation device according to claim 1.

11. The printing system according to claim 10, further comprising:
a light source that irradiates the substrate with an active energy ray,
wherein the relative moving mechanism relatively moves the light source and the substrate in the direction parallel to the installation surface,
the liquid has an active energy ray curing property, and
the control device reduces an irradiation amount of the active energy ray for the liquid applied to the protruding and recessed surface in initial relative movement relative to an irradiation amount of the active energy ray for the liquid applied in the relative movement performed for a second times or later.

12. The printing system according to claim 10,
wherein the liquid has an insulating property.

13. A printing data generation method of generating printing data of a printing apparatus which forms a three-dimensional structure of a liquid by applying, based on the printing data, the liquid to a protruding and recessed surface including a component top surface and an installation surface of a substrate having the installation surface on which a component is installed, the printing apparatus including a liquid jetting head including a nozzle that jets a liquid, a relative moving mechanism that relatively moves the liquid jetting head and the substrate in a direction parallel to the installation surface, and a control device that laminates the protruding and recessed surface with the liquid for each relative movement by jetting the liquid to the protruding and recessed surface of the substrate from the nozzle based on the printing data,
the printing data generation method comprising:
an acquisition step of acquiring three-dimensional data of the three-dimensional structure to be formed using the liquid;
a conversion step of converting the three-dimensional data into a plurality of pieces of two-dimensional slice data in a lamination order by dividing the three-dimensional data in the direction parallel to the installation surface; and
a processing step of performing any of first shift processing of shifting data of a region of the component top surface in a lamination direction of the liquid in the three-dimensional data to the lamination direction, second shift processing of shifting the data of the region of the component top surface in the lamination direction in the plurality of pieces of two-dimensional slice data to the lamination direction, or rearrangement processing of rearranging the lamination order of the plurality of pieces of two-dimensional slice data.

14. A manufacturing method of a three-dimensional structure, comprising:
the printing data generation method according to claim 13; and
a lamination step of relatively moving a liquid jetting head including a nozzle that jets a liquid and a substrate having a protruding and recessed surface including a component top surface and an installation surface on which a component is installed, in a direction parallel to the installation surface, and jetting the liquid to the protruding and recessed surface of the substrate from the nozzle based on printing data to laminate the protruding and recessed surface with the liquid for each relative movement.

15. A non-transitory, computer-readable tangible recording medium on which a program for causing, when read by a computer, the computer to execute the printing data generation method according to claim 13 is recorded.
